(19) United States
(12) Patent Application Publication
(10) Pub. No.: US 2026/0323329 A1
(43) Pub. Date: Oct. 15, 2026

(54) LINK QUALITY DETERMINING METHOD, APPARATUS, CHIP SYSTEM, AND STORAGE MEDIUM

(71) Applicant: HUAWEI TECHNOLOGIES CO., LTD., Shenzhen (CN)

(72) Inventors: Hejia Luo, Ottawa (CA); Chuili Kong, Hangzhou (CN); Xiaolu Wang, Hangzhou (CN); Yu Wang, Hangzhou (CN); Jun Wang, Hangzhou (CN)

(21) Appl. No.: 19/463,346

(22) Filed: Jan. 29, 2026

Related U.S. Application Data
(63) Continuation of application No. PCT/CN2023/111205, filed on Aug. 4, 2023.

(51) Int. Cl. H04W 24/08; H04W 84/06

(52) U.S. Cl. CPC H04W 24/08; H04W 84/06

(57) ABSTRACT

This disclosure discloses a link quality determining method, an apparatus, a chip system, and a storage medium, to determine quality information of at least one segment of link between two apparatuses based on measurement results of at least two reference signals. According to the method, a first apparatus obtains first information indicating a relationship between transmit power values of at least two reference signals sent by a second apparatus. The first apparatus determines quality information of at least one link based on the first information and measurement information of the at least two reference signals. A first link in the at least one link includes a link from the second apparatus to a second relay apparatus or a link from a third apparatus to a first relay apparatus.

### CROSS-REFERENCE TO RELATED APPLICATIONS

This application is a continuation of International Application No. PCT/CN2023/111205, filed on Aug. 4, 2023, the disclosure of which is hereby incorporated by reference in its entirety.

### TECHNICAL FIELD

This disclosure relates to the field of communication technologies, and in particular, to a link quality determining method, an apparatus, a chip system, and a storage medium.

### BACKGROUND

Currently, 5th generation (5G) new radio (NR) has entered a commercial deployment phase following a standardization phase. An NR standard is researched and designed for a characteristic of terrestrial communication, and is capable of of providing high-rate, high-reliability, and low-latency communication for user terminals. Compared with terrestrial communication, non-terrestrial network (NTN) communication exhibits characteristics such as wide-area coverage and flexible networking. Currently, research institutes, communication organizations, companies, and the like have participated in researching NTN communication technologies and standards, with an objective of building an integrated communication network for space-air-ground communication.

The NTN communication may include networking by using devices such as an uncrewed aerial vehicle, a high-altitude platform, and a satellite, to provide services such as data transmission and voice communication for user terminals (UE). In NTN communication scenarios involving devices such as a satellite, a network element originally located on the ground may be deployed on the satellite. For example, a radio access network (RAN) device is deployed on the satellite, and a user plane function (UPF) network element is deployed on the satellite.

In the NTN communication, data is forwarded one or more times from a transmit end to a receive end. This may also be understood as that one or more relay apparatuses are further included between the transmit end and the receive end, and the relay apparatus may include devices such as an uncrewed aerial vehicle, a high-altitude platform, or a satellite, or an apparatus in the device. Quality of a link from the transmit end to the receive end is an important parameter in the communication scenarios. The parameter may assist in data scheduling and/or apparatus power control, so as to reduce power consumption and the like.

Therefore, how to obtain quality information of a link becomes an urgent problem that needs to be addressed.

### SUMMARY

This disclosure provides a link quality determining method, an apparatus, a chip system, and a storage medium, to determine quality information of at least one segment of link between two apparatuses based on a relationship between transmit power values of at least two reference signals and measurement results of the at least two reference signals.

In an implementation, a link between a transmit end and a receive end usually includes one or more relay apparatuses. The transmit end sends a reference signal to the receive end, and the receive end measures the reference signal, and obtains quality information of the link based on a measurement result. The quality information of the link is quality information of the entire link from the transmit end to the receive end, and is not quality information of a segment of link (at least one end of the segment of link is a relay apparatus) between the transmit end and the receive end.

However, in the solution provided in this disclosure, a first apparatus may obtain quality information of a first link, and at least one end of the first link is a relay apparatus. The quality information of the first link may assist in controlling a transmit power value of a third apparatus, a second apparatus, or the relay apparatus, or may be used to determine selection of a working mode of the relay apparatus, so that power consumption of each apparatus can be reduced as much as possible when link quality is satisfied.

According to a first aspect, this disclosure provides a link quality determining method. The method is applicable to a first apparatus. The first apparatus may be a terminal or a chip system inside the terminal. The first apparatus may alternatively be a network device or a chip system inside the network device. The first apparatus may alternatively be another device, for example, an NTN device or a chip system inside the NTN device. For example, the first apparatus may be a satellite or a chip system inside the satellite.

In the method, the first apparatus obtains first information. The first information indicates a relationship between transmit power values of at least two reference signals sent by a second apparatus. The first apparatus obtains at least two pieces of measurement information. The at least two pieces of measurement information are obtained based on the at least two reference signals from the second apparatus. The first apparatus determines quality information of at least one link based on the first information and the at least two pieces of measurement information. At least one relay apparatus is included between a third apparatus and the second apparatus, and a first relay apparatus and a second relay apparatus are a same relay apparatus or different relay apparatuses in the at least one relay apparatus. The at least one link includes a first link, and the first link includes a link from the second apparatus to the second relay apparatus or a link from the third apparatus to the first relay apparatus.

Because the second apparatus sends the at least two reference signals, and the first information obtained by the first apparatus further indicates a relationship between transmit power values of the at least two reference signals, the first apparatus may determine quality information of a segment of link from the third apparatus or the second apparatus to the relay apparatus based on the first information and measurement result information of the at least two reference signals. The link quality information may be used for control of a transmit power value of at least one of the third apparatus, the second apparatus, or the relay apparatus, or may be used for selection of a working mode of the relay apparatus, to reduce power consumption as much as possible when ensuring link quality.

The first apparatus and the third apparatus may be a same apparatus or two different apparatuses. In an example embodiment, when the first apparatus and the third apparatus are a same apparatus, the first apparatus receives the at least two reference signals from the second apparatus, and the first apparatus measures the at least two reference signals, to obtain the at least two pieces of measurement information. When the first apparatus and the third apparatus are not a same apparatus, the first apparatus receives the at least two pieces of measurement information. For example, the first apparatus receives the at least two pieces of measurement information from the third apparatus.

In an example embodiment, in a link between the third apparatus and the second apparatus, no other relay apparatus is included between the second apparatus and the second relay apparatus, and no other relay apparatus is included between the first relay apparatus and the third apparatus. It can be seen that the first link is a segment of link between the second apparatus (or the third apparatus) and a relay apparatus adjacent to the second apparatus (or the third apparatus). Therefore, adjusting a transmit power value of each apparatus based on the segment of link can more effectively adjust quality of data reaching a receive end, and can also reduce power overheads of a transmit end.

In an example embodiment, when the third apparatus includes the terminal, and the second apparatus includes the network device, the first link includes the link from the third apparatus to the first relay apparatus. In another example embodiment, when the third apparatus includes the network device, and the second apparatus includes the terminal, the first link includes the link from the second apparatus to the second relay apparatus. In the two implementations, the first apparatus may obtain quality information of a user link on a terminal side, and then quality information of the first link may be used to adjust a transmit power value of each apparatus and/or select a working mode of the relay apparatus, so that power consumption of the terminal and/or the relay apparatus can be reduced as much as possible on the premise that quality of the user link is within a proper range.

In an example embodiment, the at least one link includes a second link. When the first link includes the link from the third apparatus to the first relay apparatus, the second link includes a link from the first relay apparatus to the second apparatus. When the first link includes the link from the second apparatus to the second relay apparatus, the second link includes a link from the second relay apparatus to the third apparatus. In this way, quality information of two segments of link between the third apparatus and the second apparatus may provide more reference bases for adjusting the transmit power value of each apparatus and/or selecting the working mode of the relay apparatus, so that the adjustment of the transmit power value of each apparatus and/or the selection of the working mode of the relay apparatus may be more accurate.

In an example embodiment, the quality information of the at least one link is used to determine at least one of the following content: a transmit power value of the third apparatus; a transmit power value of the second apparatus; a transmit power value of a relay apparatus in the at least one relay apparatus; or a working mode of a relay apparatus in the at least one relay apparatus. In this embodiment, an apparatus that determines the transmit power value of each apparatus and/or the working mode of the relay apparatus based on the quality information of the at least one link may be the first apparatus. For example, the first apparatus determines, based on the quality information of the at least one link, a transmit power value of at least one of the third apparatus, the second apparatus, or the at least one relay apparatus, and/or the working mode of the relay apparatus in the at least one relay apparatus.

Alternatively, in this embodiment, an apparatus that determines the transmit power value of each apparatus and/or the working mode of the relay apparatus based on the quality information of the at least one link may not be the first apparatus. For example, the first apparatus sends the quality information of the at least one link, so that an apparatus (for example, a fourth apparatus) that receives the quality information of the at least one link determines, based on the quality information of the at least one link, the transmit power value of each apparatus and/or the working mode of the relay apparatus.

The first apparatus obtains the first information in a plurality of manners. For example, the first apparatus generates the first information. Alternatively, the first apparatus receives the first information. For example, the first apparatus receives the first information from the second apparatus.

In an example embodiment, the first information includes information indicating a relationship between transmit power values of a plurality of reference signals in the at least two reference signals sent by the second apparatus. For example, the first information includes information indicating a multiple relationship of the transmit power values of the plurality of reference signals sent by the second apparatus. The first apparatus may resolve the quality information of the at least one link by using the information about the multiple relationship.

In another example embodiment, the first information includes information indicating a transmit power value of a reference signal in the at least two reference signals sent by the second apparatus. In this way, the first apparatus may directly calculate the quality information of the at least one link by using the transmit power value of each reference signal.

According to a second aspect, this disclosure provides a link quality determining method. The method is applicable to a fourth apparatus. The fourth apparatus may be a terminal or a chip system inside the terminal. The fourth apparatus may alternatively be a network device or a chip system inside the network device. The fourth apparatus may alternatively be another device, for example, an NTN device or a chip system inside the NTN device. For example, the fourth apparatus may be a satellite or a chip system inside the satellite.

In the method, the fourth apparatus obtains quality information of at least one link. At least one relay apparatus is included between a third apparatus and a second apparatus. The at least one link includes a first link. The first link includes a link from the second apparatus to a second relay apparatus or a link from the third apparatus to a first relay apparatus. The first relay apparatus and the second relay apparatus are a same relay apparatus or different relay apparatuses in the at least one relay apparatus. The fourth apparatus determines a transmit power value of at least one of the third apparatus, the second apparatus, or the at least one relay apparatus based on the quality information of the at least one link.

Because the fourth apparatus may control, based on the quality information of the at least one link, the transmit power value of the at least one of the third apparatus, the second apparatus, or the relay apparatus, power consumption can be reduced as much as possible when link quality is ensured.

In an example embodiment, when the third apparatus includes a terminal, the second apparatus includes a network device, and the first link includes the link from the third apparatus to the first relay apparatus, if link quality indicated by the quality information of the first link is not greater than a quality threshold, the fourth apparatus determines to increase a transmit power value of the first relay apparatus. In this way, quality of a signal received by the third apparatus can be improved, thereby improving data transmission reliability.

In an example embodiment, when the third apparatus includes a terminal, the second apparatus includes a network device, and the first link includes the link from the third apparatus to the first relay apparatus, if link quality indicated by the quality information of the first link is greater than a quality threshold, the fourth apparatus determines to reduce a transmit power value of the first relay apparatus. In this way, power consumption of the first relay apparatus can be reduced.

In an example embodiment, when the third apparatus includes a network device, the second apparatus includes a terminal, and the first link includes the link from the second apparatus to the second relay apparatus, if link quality indicated by the quality information of the first link is not greater than a quality threshold, the fourth apparatus determines to increase a transmit power value of the second apparatus. In this way, quality of a signal received by the third apparatus can be improved, thereby improving data transmission reliability.

In an example embodiment, when the third apparatus includes a network device, the second apparatus includes a terminal, and the first link includes the link from the second apparatus to the second relay apparatus, if link quality indicated by the quality information of the first link is greater than a quality threshold, the fourth apparatus determines to reduce a transmit power value of the second apparatus. In this way, power consumption of the second apparatus can be reduced.

In an example embodiment, when link quality indicated by the quality information of the first link is not greater than a quality threshold, and a difference between the link quality indicated by the quality information of the first link and link quality indicated by quality information of a second link is greater than a difference threshold, the fourth apparatus determines a transmit power value of at least one of the third apparatus, the second apparatus, or the at least one relay apparatus based on the quality information of the at least one link.

When a difference between the link quality indicated by the quality information of the first link and link quality indicated by quality information of a second link is greater than a difference threshold, the fourth apparatus adjusts a transmit power value of the first relay apparatus (or the second apparatus, or another relay apparatus (for example, the second relay apparatus)), to obtain a large benefit. For example, when the fourth apparatus uses this implementation, reliability of data received by the third apparatus can be greatly improved or power consumption of the relay apparatus (or the second apparatus) can be greatly reduced by using a small transmit power value adjustment amount.

In an example embodiment, the fourth apparatus may further perform at least one of the following: The fourth apparatus sends information indicating a transmit power value of the third apparatus; the fourth apparatus sends information indicating a transmit power value of the second apparatus; or the fourth apparatus sends information indicating a transmit power value of a relay apparatus in the at least one relay apparatus.

The fourth apparatus may send, to an apparatus only when determining that a transmit power value of the apparatus (the third apparatus, the second apparatus, or the relay apparatus) needs to be adjusted, information indicating the transmit power value of the apparatus. Alternatively, the fourth apparatus may not determine whether an apparatus needs to adjust a transmit power value, and the fourth apparatus sends information indicating the transmit power value of the apparatus to the apparatus, so that the apparatus determines whether the current transmit power value needs to be adjusted.

According to a third aspect, this disclosure provides a link quality determining method. The method is applicable to a fourth apparatus. The fourth apparatus may be a terminal or a chip system inside the terminal. The fourth apparatus may alternatively be a network device or a chip system inside the network device. The fourth apparatus may alternatively be another device, for example, an NTN device or a chip system inside the NTN device. For example, the fourth apparatus may be a satellite or a chip system inside the satellite.

The method includes: The fourth apparatus obtains quality information of at least one link. At least one relay apparatus is included between a third apparatus and a second apparatus. The at least one link includes a first link. The first link includes a link from the second apparatus to a second relay apparatus or a link from the third apparatus to a first relay apparatus. The first relay apparatus and the second relay apparatus are a same relay apparatus or different relay apparatuses in the at least one relay apparatus. The fourth apparatus determines a working mode of a relay apparatus in the at least one relay apparatus based on the quality information of the at least one link.

Because the fourth apparatus may determine the working mode of the relay apparatus based on the quality information of the at least one link, power consumption of the relay apparatus can be reduced as much as possible when link quality is ensured.

In an example embodiment, when a difference between link quality indicated by quality information of the first link and link quality indicated by quality information of a second link is not greater than a difference threshold, the working mode of the relay apparatus in the at least one relay apparatus is a first mode. For example, that the relay apparatus works in the first mode includes: The relay apparatus decodes and forwards a received signal. The relay apparatus is an NTN device like a satellite. When quality of links on two sides of the relay apparatus is similar, a capacity (a quantity of bits transmitted per second) of the relay apparatus in two modes differs greatly. In this case, the relay apparatus may work in the first mode as much as possible. In the first mode, the capacity (the quantity of bits transmitted per second) of the relay apparatus is large. Therefore, this solution can improve overall system performance.

In an example embodiment, when a difference between link quality indicated by quality information of the first link and link quality indicated by quality information of a second link is greater than a difference threshold, the working mode of the relay apparatus in the at least one relay apparatus is a second mode. For example, that the relay apparatus works in the second mode includes: The relay apparatus amplifies and forwards a received signal. This may also be understood as that the relay apparatus does not perform a decoding operation on the received signal when the relay apparatus works in the second mode. When quality of links on two sides of the relay apparatus differs greatly, the capacity (a quantity of bits transmitted per second) of the relay apparatus in two modes differs slightly. In this case, the relay apparatus may work in the second mode as much as possible. In the second mode, power consumption overheads of the relay apparatus are relatively small. Therefore, this solution can reduce power consumption of the relay apparatus.

In an example embodiment, when a difference between link quality indicated by quality information of the first link and link quality indicated by quality information of a second link is equal to a difference threshold, the working mode of the relay apparatus in the at least one relay apparatus is a first mode or a second mode.

In this embodiment, the fourth apparatus and a relay apparatus whose working mode needs to be adjusted may be in a same device, or may be in different devices. When the fourth apparatus and the relay apparatus are in different devices, the fourth apparatus sends information indicating the working mode of the relay apparatus in the at least one relay apparatus. In this way, the relay apparatus that receives the information may adjust the working mode of the relay apparatus based on the information.

In an example embodiment, when determining that a relay apparatus needs to adjust a working mode, the fourth apparatus may send, to the relay apparatus, information indicating the working mode of the relay apparatus.

In another example embodiment, the fourth apparatus does not need to determine whether a relay apparatus needs to switch a working mode, and the fourth apparatus sends, to the relay apparatus, information indicating the working mode of the relay apparatus. The relay apparatus that receives the information may autonomously determine whether the working mode needs to be switched. For example, the relay apparatus may determine, when the current working mode of the relay apparatus is different from the working mode indicated by the information, that the working mode needs to be switched.

According to a fourth aspect, this disclosure provides a link quality determining method. The method is applicable to a second apparatus. The second apparatus may be a terminal or a chip system inside the terminal. The second apparatus may alternatively be a network device or a chip system inside the network device. The second apparatus may alternatively be another device, for example, an NTN device or a chip system inside the NTN device. For example, the fourth apparatus may be a satellite or a chip system inside the satellite.

In the method, the second apparatus obtains first information, where the first information indicates a relationship between transmit power values of at least two reference signals sent by the second apparatus. The second apparatus sends the at least two reference signals based on the first information.

In this way, the transmit power values of the at least two reference signals sent by the second apparatus meet a requirement of the first information, and then a first apparatus can determine, based on the first information and measurement result information of the at least two reference signals, quality information of a segment of link from a third apparatus or the second apparatus to a relay apparatus. The link quality information may be used for control of a transmit power value of at least one of the third apparatus, the second apparatus, or the relay apparatus, or may be used for selection of a working mode of the relay apparatus, to reduce power consumption as much as possible when ensuring link quality.

In an example embodiment, the second apparatus may receive the first information from another apparatus, or the second apparatus may autonomously generate the first information. In another example embodiment, the second apparatus may send the first information. For example, the second apparatus may send the first information to the first apparatus.

In an example embodiment, the first information includes information indicating at least one of the following: a relationship between transmit power values of a plurality of reference signals in the at least two reference signals sent by the second apparatus; and/or transmit power values of reference signals in the at least two reference signals sent by the second apparatus. According to a fifth aspect, this disclosure provides a link quality determining method. The method is applicable to a third apparatus. The third apparatus may be a terminal or a chip system inside the terminal. The third apparatus may alternatively be a network device or a chip system inside the network device. The third apparatus may alternatively be another device, for example, an NTN device or a chip system inside the NTN device. For example, the fourth apparatus may be a satellite or a chip system inside the satellite.

The method includes: The third apparatus receives at least two reference signals. The third apparatus measures the at least two reference signals, to obtain at least two pieces of measurement information.

The measurement result information of the at least two reference signals may be used to determine quality information of a segment of link from the third apparatus or a second apparatus to a relay apparatus. The link quality information may be used for control of a transmit power value of at least one of the third apparatus, the second apparatus, or the relay apparatus, or may be used for selection of a working mode of the relay apparatus, to reduce power consumption as much as possible when ensuring link quality.

According to a sixth aspect, a communication apparatus is provided. The communication apparatus may be the foregoing first apparatus, second apparatus, third apparatus, or fourth apparatus. The communication apparatus may include a communication unit and a processing unit, to perform any one of the first aspect to the fifth aspect or perform any one of the example embodiments of the first aspect to the fifth aspect. The communication unit is configured to perform functions related to sending and receiving. Optionally, the communication unit includes a receiving unit and a sending unit. In an example embodiment, the communication apparatus is a communication chip, the processing unit may be one or more processors or processor cores, and the communication unit may be an input/output circuit or a port of the communication chip.

In another example embodiment, the communication unit may be a transmitter and a receiver, or the communication unit may be a transmitter machine and a receiver machine.

Optionally, the communication apparatus further includes modules that may be configured to perform any one of the first aspect to the fifth aspect or perform any one of the example embodiments of the first aspect to the fifth aspect.

According to a seventh aspect, a communication apparatus is provided. The communication apparatus may be the foregoing first apparatus, second apparatus, third apparatus, or fourth apparatus. The communication apparatus may include a processor and a memory, to perform any one of the first aspect to the fifth aspect or perform any one of the example embodiments of the first aspect to the fifth aspect. Optionally, a transceiver is further included. The memory is configured to store a computer program or instructions. The processor is configured to invoke the computer program or the instructions from the memory and run the computer program or the instructions. When the processor executes the computer program or the instructions in the memory, the communication apparatus is caused to perform any one of the first aspect to the fifth aspect, or perform any one of the example embodiments of the first aspect to the fifth aspect.

Optionally, there are one or more processors, and there are one or more memories.

Optionally, the memory may be integrated with the processor, or the memory and the processor are disposed separately.

Optionally, the transceiver may include a transmitter machine (transmitter) and a receiver machine (receiver).

According to an eighth aspect, a communication apparatus is provided. The communication apparatus may be the foregoing first apparatus, second apparatus, third apparatus, or fourth apparatus. The communication apparatus may include a processor, to perform any one of the first aspect to the fifth aspect or perform any one of the example embodiments of the first aspect to the fifth aspect. The processor is coupled to a memory. Optionally, the communication apparatus further includes the memory. Optionally, the communication apparatus further includes a communication interface, and the processor is coupled to the communication interface.

In an implementation, when the communication apparatus is the first apparatus, the second apparatus, the third apparatus, or the fourth apparatus, the communication interface may be a transceiver or an input/output interface. Optionally, the transceiver may be a transceiver circuit. Optionally, the input/output interface may be an input/output circuit.

In another implementation, when the communication apparatus is a chip or a chip system, the communication interface may be an input/output interface, an interface circuit, an output circuit, an input circuit, a pin, a related circuit, or the like on the chip or the chip system. The processor may alternatively be embodied as a processing circuit or a logic circuit.

According to a ninth aspect, a system is provided. The system includes the foregoing first apparatus.

In an example embodiment, the system may further include the fourth apparatus. In another example embodiment, the system may further include the second apparatus and the third apparatus.

According to a tenth aspect, a computer program product is provided. The computer program product includes a computer program (which may also be referred to as code or instructions). When the computer program runs, a computer is caused to perform any one of the first aspect to the fifth aspect, or perform any one of the example embodiments of the first aspect to the fifth aspect.

According to an eleventh aspect, a computer-readable storage medium is provided. The computer-readable storage medium stores a computer program (which may also be referred to as code or instructions). When the computer program runs on a computer, the computer is caused to perform any one of the first aspect to the fifth aspect, or perform any one of the example embodiments of the first aspect to the fifth aspect.

According to a twelfth aspect, a chip system is provided. The chip system may include a processor. The processor is coupled to a memory, and may be configured to perform any one of the first aspect to the fifth aspect, or perform any one of the example embodiments of the first aspect to the fifth aspect. Optionally, the chip system further includes the memory. The memory is configured to store a computer program (which may also be referred to as code or instructions). The processor is configured to invoke the computer program from the memory and run the computer program, to cause a device on which the chip system is installed to perform any one of the first aspect to the fifth aspect, or perform any one of the example embodiments of the first aspect to the fifth aspect.

According to a thirteenth aspect, a processing apparatus is provided, and includes an interface circuit and a processing circuit. The interface circuit may include an input circuit and an output circuit. The processing circuit is configured to receive a signal through the input circuit, and transmit a signal through the output circuit, so that any one the first aspect to the fifth aspect or any one of the example embodiments of the first aspect to the fifth aspect is implemented.

In a specific implementation process, the processing apparatus may be a chip, the input circuit may be an input pin, the output circuit may be an output pin, and the processing circuit may be a transistor, a gate circuit, a trigger, various logic circuits, or the like. An input signal received by the input circuit may be received and input by, for example, but not limited to, a receiver, a signal output by the output circuit may be output to, for example, but not limited to, a transmitter and transmitted by the transmitter, and the input circuit and the output circuit may be a same circuit, where the circuit is used as the input circuit and the output circuit at different moments. Specific implementations of a processor and various circuits are not limited in this disclosure.

In an implementation, when a communication apparatus is the first apparatus, the second apparatus, the third apparatus, or the fourth apparatus, the interface circuit may be a radio frequency processing chip in the first apparatus, the second apparatus, the third apparatus, or the fourth apparatus, and the processing circuit may be a baseband processing chip in the first apparatus, the second apparatus, the third apparatus, or the fourth apparatus.

In another implementation, the communication apparatus may be some components in the first apparatus, the second apparatus, the third apparatus, or the fourth apparatus, for example, an integrated circuit product like a system chip or a communication chip. The interface circuit may be an input/output interface, an interface circuit, an output circuit, an input circuit, a pin, a related circuit, or the like on the chip or the chip system. The processing circuit may be a logic circuit on the chip.

### BRIEF DESCRIPTION OF DRAWINGS

FIG. 1 is a diagram of an architecture of a communication system to which an embodiment of this disclosure is applicable;

FIG. 2 is a diagram of a network architecture of another communication system to which an embodiment of this disclosure is applicable;

FIG. 3 is a diagram of a network architecture of another communication system to which an embodiment of this disclosure is applicable;

FIG. 4 is a diagram of a network architecture of another communication system to which an embodiment of this disclosure is applicable;

FIG. 5 is a diagram of a network architecture of another communication system to which an embodiment of this disclosure is applicable;

FIG. 6 is a schematic flowchart of a communication method according to an embodiment of this disclosure;

FIG. 7 is a schematic flowchart of a communication method according to an embodiment of this disclosure;

FIG. 8 is a schematic flowchart of a communication method according to an embodiment of this disclosure;

FIG. 9 is a diagram of a communication apparatus according to an embodiment of this disclosure; and

FIG. 10 is a diagram of another communication apparatus according to an embodiment of this disclosure.

### DESCRIPTION OF EMBODIMENTS

The following first describes nouns or terms in embodiments of this disclosure.

### (1) Reference Signal

The reference signal in embodiments of this disclosure may include at least one of the following: a demodulation reference signal (DMRS), or another reference signal, for example, a phase tracking reference signal (PTRS), a channel state information reference signal (CSI-RS), a sounding reference signal (SRS), a tracking reference signal (TRS), or a synchronization broadcast block (synchronization signal and PBCH block, SSB). For example, the reference signal may further include a primary synchronization signal (PSS), a secondary synchronization signal (SSS), or a DMRS in the SSB.

Technical solutions provided in embodiments of this disclosure may be applied to an NR system, a long term evolution (LTE) system, and a non-terrestrial network (NTN) system, or may be applied to a next generation mobile communication system or another similar communication system. The technical solutions provided in embodiments of this disclosure may be further applied to a vehicle-to-everything (V2X) system, an internet of things (IoT) system, and the like.

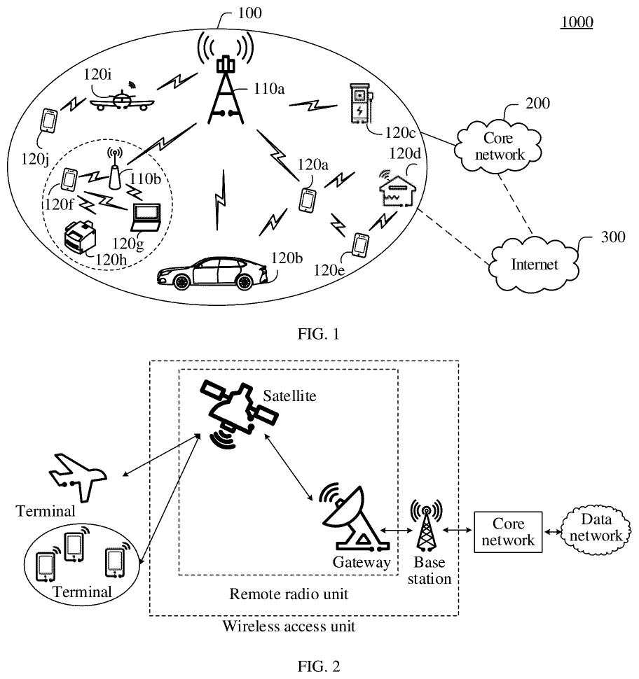

In an example, FIG. 1 is a diagram of an architecture of a communication system 1000 to which an embodiment of this disclosure is applied. As shown in FIG. 1, the communication system includes a radio access network (RAN) 100 and a core network 200. Optionally, the communication system 1000 may further include an internet 300. The RAN 100 may include at least one RAN node (for example, 110a and 110b in FIG. 1, which are collectively referred to as 110), and may further include at least one terminal (for example, 120a to 120j in FIG. 1, which are collectively referred to as 120). The RAN 100 may further include another RAN node, for example, a wireless relay device and/or a wireless backhaul device (not shown in FIG. 1). The terminal 120 is connected to the RAN node 110 in a wireless manner, and the RAN node 110 is connected to the core network 200 in a wireless or wired manner. A core network device in the core network 200 and the RAN node 110 in the RAN 100 may be independent and different physical devices, or may be a same physical device that integrates a logical function of the core network device and a logical function of the RAN node. Terminals may be connected to each other in a wired or wireless manner and RAN nodes may be connected to each other in a wired or wireless manner.

The RAN 100 may be an evolved universal terrestrial radio access (E-UTRA) system, a new radio (NR) system, or a future radio access system defined in the 3rd generation partnership project (3GPP), or may be a Wi-Fi system. The RAN 100 may further include the foregoing two or more different radio access systems. The RAN 100 may alternatively be an open RAN (O-RAN).

A RAN node, also referred to as a radio access network device, a RAN entity, or an access node, is configured to help a terminal access a communication system in a wireless manner. In an application scenario, the RAN node may be a base station, an evolved NodeB (eNodeB), a transmission reception point (TRP), a next generation NodeB (gNB) in a 5th generation (5G) mobile communication system, a next generation base station in a 6th generation (6G) mobile communication system, a base station in a future mobile communication system, or an access node in a Wi-Fi system. The RAN node may be a macro base station (for example, 110a in FIG. 1), may be a micro base station or an indoor base station (for example, 110b in FIG. 1), or may be a relay node or a donor node.

In another application scenario, a plurality of RAN nodes may cooperate to help a terminal implement radio access, and different RAN nodes separately implement some functions of a base station. For example, the RAN node may be a central unit (CU), a distributed unit (DU), or a radio unit (RU). The CU herein completes functions of a radio resource control protocol and a packet data convergence protocol (PDCP) of the base station, and may further complete a function of a service data adaptation protocol (SDAP). The DU completes functions of a radio link control layer and a medium access control (MAC) layer of the base station, and may further complete a part or all of functions of a physical layer. For specific descriptions of the foregoing protocol layers, reference is made to related technical specifications in 3GPP. The RU may be configured to implement a transceiver function of a radio frequency signal. The CU and the DU may be two independent RAN nodes, or may be integrated into a same RAN node, for example, integrated into a baseband unit (BBU). The RU may be included in a radio frequency device, for example, included in a remote radio unit (RRU) or an active antenna unit (AAU). The CU may be further classified into two types of RAN nodes: a CU-control plane and a CU-user plane.

In different systems, the RAN node may have a different name. For example, in an O-RAN system, a CU may be referred to as an open CU (O-CU), a DU may be referred to as an open DU (O-DU), and an RU may be referred to as an open RU (O-RU). The RAN node in embodiments of this disclosure may be implemented by using a software module, a hardware module, or a combination of a software module and a hardware module. For example, the RAN node may be a server to which a corresponding software module is loaded. A specific technology and a specific device form that are used by the RAN node are not limited in embodiments of this disclosure. For ease of description, the following uses a base station as an example of the RAN node for description.

The terminal is a device having a wireless transceiver function, and may send a signal to a base station, or receive a signal from a base station. The terminal may also be referred to as user equipment (UE), a mobile station, a mobile terminal, or the like. The terminal may be widely used in various scenarios, for example, device-to-device (D2D), vehicle to everything (V2X) communication, machine-type communication (MTC), internet of things (IoT), virtual reality, augmented reality, industrial control, self-driving, telemedicine, smart grid, smart furniture, smart office, smart wearable, smart transportation, and smart city. The terminal may be a mobile phone, a tablet computer, a computer with a wireless transceiver function, a wearable device, a vehicle, an airplane, a ship, a robot, a robotic arm, a smart home device, or the like. A specific technology and a specific device form that are used by the terminal are not limited in embodiments of this disclosure.

The base station and the terminal may be fixed or movable. The base station and the terminal may be deployed on land, including an indoor or outdoor device, a hand-held device, or a vehicle-mounted device, or may be deployed on water, or may be deployed on an airplane, a balloon, or an artificial satellite. Application scenarios of the base station and the terminal are not limited in embodiments of this disclosure.

Roles of the base station and the terminal may be relative. For example, a helicopter or an uncrewed aerial vehicle 120i in FIG. 1 may be configured as a mobile base station, and for a terminal 120j accessing the radio access network 100 through 120i, the terminal 120i is a base station. However, for the base station 110a, 120i is a terminal. In other words, communication between 110a and 120i is performed according to a radio air interface protocol. Certainly, communication between 110a and 120i may alternatively be performed according to an interface protocol between base stations. In this case, for 110a, 120i is also a base station. Therefore, both the base station and the terminal may be collectively referred to as communication apparatuses, 110a and 110b each in FIG. 1 may be referred to as a communication apparatus having a function of a base station, and 120a to 120j each in FIG. 1 may be referred to as a communication apparatus having a function of a terminal.

Communication between the base station and the terminal, between the base stations, or between the terminals may be performed by using a licensed spectrum, or may be performed by using an unlicensed spectrum, or may be performed by using both the licensed spectrum and the unlicensed spectrum. Communication may be performed by using a spectrum below 6 gigahertz (GHz), or may be performed by using a spectrum above 6 GHz, or may be simultaneously performed by using the spectrum below 6 GHz and the spectrum above 6 GHz. A spectrum resource used for wireless communication is not limited in embodiments of this disclosure.

In embodiments of this disclosure, a function of the base station may be performed by a module (for example, a chip) in the base station, or may be performed by a control subsystem including the function of the base station. The control subsystem including the function of the base station herein may be a control center in the foregoing application scenarios, such as smart grid, industrial control, smart transportation, and smart city. A function of the terminal may alternatively be performed by a module (for example, a chip or a modem) in the terminal, or may be performed by an apparatus including the function of the terminal.

In this disclosure, the base station sends a downlink signal or downlink information to the terminal, where the downlink information is carried on a downlink channel; and the terminal sends an uplink signal or uplink information to the base station, where the uplink information is carried on an uplink channel. To communicate with the base station, the terminal needs to establish a wireless connection to a cell controlled by the base station. The cell that establishes the wireless connection to the terminal is referred to as a serving cell of the terminal. When communicating with the serving cell, the terminal is further interfered by a signal from a neighboring cell.

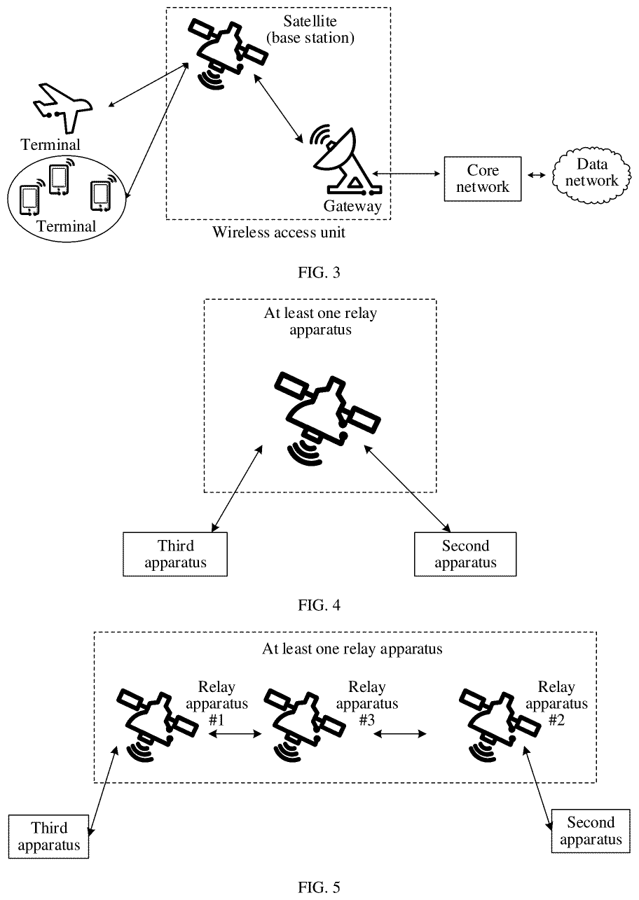

In another two examples, FIG. 2 and FIG. 3 are diagrams of network architectures of several communication systems to which an embodiment of this disclosure is applicable. The communication system includes a satellite, a terminal, and a gateway. The satellite may be a highly elliptical orbiting (HEO) satellite, a geostationary earth orbit (GEO) satellite, a medium earth orbit (MEO) satellite, and a low-earth orbit (LEO) satellite. In addition, the NTN system may further include a high-altitude platform (HAPS) and the like. This is not limited herein. The gateway (or referred to as a terrestrial station, an earth station, a signal gateway station, or a gateway station) may be used to connect the satellite and a terrestrial base station gateway station/signal gateway station (gateway). One or more satellites may be connected to one or more terrestrial base stations through one or more gateways. This is not limited herein. The terminal includes, for example, a mobile phone, an airplane, and the like (which is used as an example in FIG. 2 and FIG. 3). A link between the satellite and the terminal is referred to as a service link, and a link between the satellite and the gateway is referred to as a feeder link.

A working mode of the satellite is not limited in embodiments of this disclosure. For example, the working mode of the satellite may be a transparent mode, or may be a regenerative mode. FIG. 2 is illustrated by using an example in which the working mode of the satellite is the transparent mode, and FIG. 3 is illustrated by using an example in which the working mode of the satellite is the regenerative mode.

As shown in FIG. 2, in the transparent mode, the satellite, as an analog radio frequency repeater, has a relay forwarding function, can implement radio frequency conversion and amplification, and can transparently transmit or replicate a signal between the base station and the terminal. For example, a signal sent by the terminal may be transparently transmitted via the satellite and forwarded by the gateway to the terrestrial base station. The gateway has a part or all of functions of the base station. In this case, the gateway may be considered as a base station. It may be considered that a network element and the base station may be deployed together or separately. If the gateway and the base station are separately deployed, a delay of the feeder link includes a delay from the satellite to the gateway and a delay from the gateway to the base station.

As shown in FIG. 3, in the regenerative mode, the satellite, as a base station for wireless communication, has a part or all of functions of the base station, implements regeneration of signals received from the ground, and may understand and process the signals. For example, the satellite may be a base station mounted on an artificial earth satellite or a high-altitude aircraft. For example, the base station may be an evolved NodeB (eNB) or a 5G base station (gNB). The gateway may forward signaling between the satellite (namely, the base station) and a core network.

The satellite in FIG. 2 and FIG. 3 may alternatively be replaced with another relay device, for example, may be replaced with another NTN device like a high-altitude platform (HAPS).

Embodiments of this disclosure are also applicable to another communication system architecture, for example, an air to ground (ATG) communication system. The communication system includes at least one network device and at least one high-altitude terminal. The high-altitude terminal includes, for example, a high-altitude aircraft and an onboard terminal.

Based on the system architectures shown in FIG. 1, FIG. 2, and FIG. 3, FIG. 4 and FIG. 5 are example diagrams of several communication system architectures to which embodiments of this disclosure are applicable.

As shown in FIG. 4 and FIG. 5, at least one relay apparatus is disposed between a third apparatus and a second apparatus.

The third apparatus in this embodiment may be the terminal in FIG. 1, FIG. 2, or FIG. 3, or a chip system inside the terminal. The third apparatus may alternatively be a network device (for example, an access network device) in FIG. 1, FIG. 2, or FIG. 3, or a chip system inside the network device. The third apparatus may alternatively be another device in FIG. 1, FIG. 2, or FIG. 3, for example, an NTN device or a chip system inside the NTN device. For example, the third apparatus may be a satellite or a chip system inside the satellite.

The second apparatus in this embodiment may be the terminal in FIG. 1, FIG. 2, or FIG. 3, or a chip system inside the terminal. The second apparatus may alternatively be a network device (for example, an access network device) in FIG. 1, FIG. 2, or FIG. 3, or a chip system inside the network device. The second apparatus may alternatively be another device in FIG. 1, FIG. 2, or FIG. 3, for example, an NTN device or a chip system inside the NTN device. For example, the second apparatus may be a satellite or a chip system inside the satellite.

There is no limitation relationship between the third apparatus and the second apparatus in this embodiment. Device types of the third apparatus and the second apparatus may be the same or may be different. The device types include, for example, a terminal, a network apparatus, or an NTN device. For example, the third apparatus and the second apparatus may be respectively a terminal or a network device (where the third apparatus is the terminal or the second apparatus is the terminal), or may be respectively an NTN device and a network device, or may be respectively an NTN device and a terminal. For another example, both the third apparatus and the second apparatus may be terminals, network devices, or NTN devices such as satellites.

FIG. 4 is illustrated by using an example in which a connection is established between the third apparatus and the second apparatus through one relay apparatus. FIG. 5 is illustrated by using an example in which a connection is established between the third apparatus and the second apparatus through a plurality of relay apparatuses (for example, a relay apparatus #1, a relay apparatus #3, and a relay apparatus #2). In actual application, more relay apparatuses, for example, more than three relay apparatuses, may be included between the third apparatus and the second apparatus. In this embodiment, another apparatus like a gateway or a base station may be further included between the third apparatus and the second apparatus. This is not shown in FIG. 4 and FIG. 5.

The relay apparatus in embodiments of this disclosure may be a relay device or a chip system inside the relay device. The relay device may be the satellite or the like in FIG. 2 and FIG. 3, or may be another device, for example, another NTN device like a high-altitude platform, an uncrewed aerial vehicle, or an HAPS. In FIG. 4 and FIG. 5, an example in which the relay apparatus is the satellite is used for description.

It can be seen from the system architectures in FIG. 4 and FIG. 5 that, data transmission between the third apparatus and the second apparatus is usually performed through one or more relay apparatuses. A reference signal may be transmitted between the third apparatus and the second apparatus, and a measurement result of the reference signal may be used to determine quality information (for example, a signal-to-noise ratio (SNR) or a signal to interference plus noise ratio (SINR)) of a link. However, currently, the quality information that is of the link and that is determined based on the measurement result of the reference signal transmitted between the third apparatus and the second apparatus is quality information of the entire link between the third apparatus and the second apparatus. At present, there is no solution that can be used to determine quality information of one or more segments of link between the third apparatus and the second apparatus (for example, a link from the third apparatus to the relay apparatus or a link from the second apparatus to the relay apparatus).

Based on the foregoing content, embodiments of this disclosure provide a solution. In the solution, a second apparatus sends at least two reference signals. A first apparatus obtains first information, where the first information indicates a relationship between transmit power values of the at least two reference signals. The first apparatus determines, based on the first information and measurement result information of the at least two reference signals, quality information of one or more segments of link between a third apparatus and the second apparatus (for example, a link from the third apparatus to a relay apparatus or a link from the second apparatus to a relay apparatus). The link quality information may be used for power control of at least one of the third apparatus, the second apparatus, or the relay apparatus, or may be used for selection of a working mode of the relay apparatus.

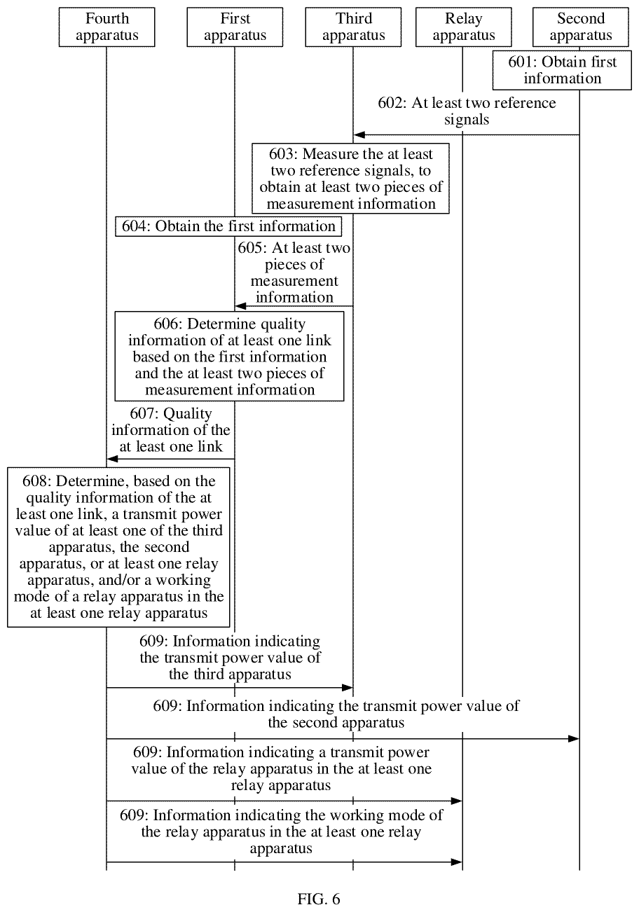

Based on the embodiments shown in FIG. 1, FIG. 2, FIG. 3, FIG. 4, and FIG. 5 and the foregoing other content, FIG. 6 is an example of a schematic flowchart of a communication method according to an embodiment of this disclosure.

For ease of understanding, FIG. 6 is described from a perspective of interaction between apparatuses. A third apparatus in FIG. 6 is the third apparatus in FIG. 4 or FIG. 5, a second apparatus in FIG. 6 is the second apparatus in FIG. 4 or FIG. 5, and a relay apparatus in FIG. 6 is the relay apparatus in FIG. 4 or FIG. 5. For related content, reference is made to the descriptions in FIG. 4 and FIG. 5.

A first apparatus and the third apparatus in FIG. 6 may be a same apparatus, or the first apparatus and the third apparatus are integrated into a same device, or the first apparatus and the third apparatus are respectively located in different devices.

In this embodiment, the first apparatus is an apparatus configured to determine quality information of at least one link. The first apparatus may be the terminal in FIG. 1, FIG. 2, or FIG. 3, or a chip system inside the terminal. The first apparatus may alternatively be a network device (for example, an access network device) in FIG. 1, FIG. 2, or FIG. 3, or a chip system inside the network device. The first apparatus may alternatively be the device in FIG. 1, FIG. 2, FIG. 3, FIG. 4, or FIG. 5, for example, an NTN device or a chip system inside the NTN device. For example, the first apparatus may be a satellite or a chip system inside the satellite.

In this embodiment, a fourth apparatus is an apparatus for performing power control or adjusting a working mode of the relay apparatus based on the quality information of the at least one link, and the fourth apparatus may alternatively be understood as an apparatus using the quality information of the at least one link. The fourth apparatus and the first apparatus may be a same apparatus, or the fourth apparatus and the first apparatus are integrated into a same device, or the fourth apparatus and the first apparatus are respectively located in different devices. The fourth apparatus may be the terminal in FIG. 1, FIG. 2, or FIG. 3, or a chip system inside the terminal. The fourth apparatus may alternatively be a network device (for example, an access network device) in FIG. 1, FIG. 2, or FIG. 3, or a chip system inside the network device. The fourth apparatus may alternatively be the device in FIG. 1, FIG. 2, FIG. 3, FIG. 4, or FIG. 5, for example, an NTN device or a chip system inside the NTN device. For example, the fourth apparatus may be a satellite or a chip system inside the satellite.

As shown in FIG. 6, the method includes the following steps.

Step 601: The second apparatus obtains first information.

The first information indicates a relationship between transmit power values of at least two reference signals sent by the second apparatus.

The first information may indicate information about the following content A1 and/or content A2.
Content A1: a relationship between transmit power values of a plurality of reference signals in the at least two reference signals sent by the second apparatus.

There may be a plurality of possible relationships between the transmit power values of the plurality of reference signals sent by the second apparatus. For example, there may be a mathematical relationship between the transmit power values of the plurality of reference signals. For example, there may be a multiple relationship or a difference relationship between two transmit power values. For example, the second apparatus sends a reference signal #1 and a reference signal #2. A transmit power value of the reference signal #1 sent by the second apparatus is 3 decibel (dB), and a transmit power value of the reference signal #2 sent by the second apparatus is 6 dB. The transmit power value of the reference signal #2 sent by the second apparatus is twice the transmit power value of the reference signal #1 sent by the second apparatus. It may be referred to as that there is a two-fold relationship between the transmit power values of the reference signal #1 and the reference signal #2 sent by the second apparatus. The first information may include information indicating that there is the two-fold relationship between the transmit power values of the reference signal #2 and the reference signal #1 sent by the second apparatus.
Content A2: a transmit power value of a reference signal in the at least two reference signals sent by the second apparatus.

With reference to the foregoing example, the first information may include information indicating a transmit power value 3 dB of the reference signal #2 sent by the second apparatus and a transmit power value 6 dB of the reference signal #1 sent by the second apparatus.

The first information may further include configuration information of the plurality of reference signals sent by the second apparatus. For example, the first information may include at least one of time domain information, frequency domain information, or polarization information of the plurality of reference signals. For another example, the first information includes a resource identifier and/or a resource set identifier of the reference signal #1 and a resource identifier and/or a resource set identifier of the reference signal #2, so that the apparatus receiving the first information determines the corresponding reference signal based on the first information.

In this embodiment, the second apparatus obtains the first information in a plurality of manners. For example, the second apparatus may generate the first information. Alternatively, the second apparatus may receive the first information from another apparatus (for example, the third apparatus).

Step 602: The second apparatus sends the at least two reference signals based on the first information.

Correspondingly, the third apparatus receives the at least two reference signals.

Transmit power values of the at least two reference signals sent by the second apparatus are consistent with content required in the first information. For example, when the first information indicates that there is a two-fold relationship between the transmit power values of the reference signal #2 and the reference signal #1, the transmit power values of the reference signal #2 and the reference signal #1 sent by the second apparatus need to meet the two-fold relationship.

Step 603: The third apparatus measures the at least two reference signals, to obtain at least two pieces of measurement information.

The at least two pieces of measurement information are obtained based on the at least two reference signals from the second apparatus.

Step 604: The first apparatus obtains the first information.

In this embodiment, the first apparatus obtains the first information in a plurality of manners. The first apparatus may generate the first information, or may receive the first information from another apparatus (for example, the second apparatus). For example, the second apparatus generates the first information, and sends the first information to the first apparatus. For another example, the first apparatus generates the first information, and sends the first information to the second apparatus.

Content of the first information obtained by the first apparatus is consistent with that of the first information in step 601.

Step 605: The third apparatus sends the at least two pieces of measurement information.

Correspondingly, the first apparatus receives the at least two pieces of measurement information.

Step 605 may alternatively be replaced with: The first apparatus obtains the at least two pieces of measurement information.

When the first apparatus and the third apparatus are a same apparatus, step 603 may be performed by the first apparatus. To be specific, the first apparatus receives the at least two reference signals from the second apparatus, and the first apparatus measures the at least two reference signals, to obtain the at least two pieces of measurement information. In this case, step 605 may not be performed.

Step 606: The first apparatus determines quality information of at least one link based on the first information and the at least two pieces of measurement information.

In this embodiment, the quality information of the at least one link includes an SNR, an SNIR, a channel quality indicator (CQI), or the like.

At least one relay apparatus is included between the third apparatus and the second apparatus. A first relay apparatus and a second relay apparatus are a same relay apparatus or different relay apparatuses in the at least one relay apparatus.

The at least one link includes a first link. The first link includes a link from the second apparatus to the second relay apparatus or a link from the third apparatus to the first relay apparatus.

The at least one link includes a second link. When the first link includes the link from the third apparatus to the first relay apparatus, the second link includes a link from the first relay apparatus to the second apparatus. When the first link includes the link from the second apparatus to the second relay apparatus, the second link includes a link from the second relay apparatus to the third apparatus.

For example, when the third apparatus includes a terminal, and the second apparatus includes a network device, the first link includes the link from the third apparatus to the first relay apparatus. For another example, when the third apparatus includes a network device, and the second apparatus includes a terminal, the first link includes the link from the second apparatus to the second relay apparatus.

In an example embodiment, in a link between the third apparatus and the second apparatus, no other relay apparatus is included between the second apparatus and the second relay apparatus, and no other relay apparatus is included between the first relay apparatus and the third apparatus.

With reference to FIG. 5, for example, the relay apparatus #1 may be considered as the first relay apparatus, and the relay apparatus #2 may be considered as the second relay apparatus. When a link from the third apparatus to the relay apparatus #1 is considered as the first link, a link from the relay apparatus #1 to the second apparatus may be considered as the second link. When a link from the second apparatus to the relay apparatus #2 is considered as the first link, a link from the relay apparatus #2 to the third apparatus may be considered as the second link.

There are a plurality of methods for obtaining quality information of the first link and/or the second link. The following describes an example embodiment by using an example. In this example, the second apparatus is a base station, the third apparatus is a terminal, the first link is the link from the third apparatus to the relay apparatus #1, and the second link is the link from the relay apparatus #1 to the second apparatus. The second apparatus sends the reference signal #1 and the reference signal #2. There is a two-fold relationship between the transmit power values of the reference signal #2 and the reference signal #1 sent by the second apparatus. The first apparatus may calculate the link quality information of the first link and/or the second link by using the following formula (1):

$$\{ \begin{matrix}{SNR}_{1} = \frac{SNR 0 \cdot SNR 1}{SNR 0 + SNR 1 + 1} \\ {SNR}_{2} = \frac{SNR 0 \cdot ( SNR 1 \times δ )}{SNR 0 + ( SNR 1 \times δ ) + 1}\end{matrix} \qquad Formula ( 1 )$$

In the formula (1), SNR₁ is measurement information obtained by the third apparatus by measuring the reference signal #1, SNR₂ is measurement information obtained by the third apparatus by measuring the reference signal #2, SNR0 is the quality information of the second link, SNR₁ is the quality information of the first link, and δ is a multiple value 2 between the transmit power values of the reference signal #2 and the reference signal #1 sent by the second apparatus.

In another implementation, for example, the second apparatus is a terminal, the third apparatus is a base station, the first link is the link from the second apparatus to the relay apparatus #2, and the second link is the link from the relay apparatus #2 to the third apparatus. The second apparatus sends the reference signal #1 and the reference signal #2. There is a two-fold relationship between the transmit power values of the reference signal #2 and the reference signal #1 sent by the second apparatus. The first apparatus may calculate the link quality information of the first link and/or the second link by using the formula (1). Similarly, in the formula (1), SNR₁ is measurement information obtained by the third apparatus by measuring the reference signal #1, SNR₂ is measurement information obtained by the third apparatus by measuring the reference signal #2, SNR0 is the quality information of the second link, SNR₁ is the quality information of the first link, and δ is a multiple value 2 between the transmit power values of the reference signal #2 and the reference signal #1 sent by the second apparatus.

In the foregoing example, because a transmit end can change, by adjusting power, only an SNR of a link directly connected to the transmit end, SNR0 does not change, and that the transmit end adjusts the power is equivalent to that SNR1 needs to be multiplied by δ in the formula corresponding to SNR₂. In some other scenarios, the foregoing formula (1) may alternatively be deformed. For example, if SNR0 also changes, SNR0 may also be multiplied by δ in the formula corresponding to SNR₂. Alternatively, a relationship between reference signals sent by the transmit end is not a multiple relationship, but another relationship, for example, a difference relationship. (SNR1×δ) in the formula for calculating SNR₂ in the foregoing formula (1) may be correspondingly replaced.

In this embodiment, the quality information of the at least one link is used to determine at least one of the following content: a transmit power value of the third apparatus; a transmit power value of the second apparatus; a transmit power value of a relay apparatus in the at least one relay apparatus; or a working mode of a relay apparatus in the at least one relay apparatus.

In the solution shown in FIG. 6, in an example embodiment, the solution further includes step 607, step 608, and step 609.

Step 607: The first apparatus sends the quality information of the at least one link.

Correspondingly, the fourth apparatus receives the quality information of the at least one link.

Step 607 may be replaced with the following: The fourth apparatus obtains the quality information of the at least one link.

When the fourth apparatus and the first apparatus are a same apparatus, the fourth apparatus obtains the quality information of the at least one link by using step 606. In this case, step 607 may not be performed.

Step 608: The fourth apparatus determines, based on the quality information of the at least one link, a transmit power value of at least one of the third apparatus, the second apparatus, or the at least one relay apparatus, and/or a working mode of a relay apparatus in the at least one relay apparatus.

In this embodiment, the quality information of the at least one link may be helpful for a plurality of scenarios. The following separately describes, by using an implementation B1 and an implementation B2, how the fourth apparatus uses the quality information of the at least one link.
Implementation B1: The fourth apparatus determines, based on the quality information of the at least one link, a transmit power value of at least one of the third apparatus, the second apparatus, or the at least one relay apparatus.
Implementation B1.1: When the third apparatus includes a terminal, the second apparatus includes a network device, and the first link includes the link from the third apparatus to the first relay apparatus, the fourth apparatus may adjust a transmit power value of the first relay apparatus based on the quality information of the first link.

The following describes two adjustment manners by using an adjustment manner B1.1.1 and an adjustment manner B1.1.2 as examples.
Adjustment manner B1.1.1: When link quality indicated by the quality information of the first link is not greater than a quality threshold, the fourth apparatus increases the transmit power value of the first relay apparatus. In this way, quality of a signal received by the third apparatus can be improved, thereby improving data transmission reliability.
Adjustment manner B1.1.2: When link quality indicated by the quality information of the first link is greater than a quality threshold, the fourth apparatus reduces the transmit power value of the first relay apparatus. In this way, power consumption of the first relay apparatus can be reduced.

In a scenario in which the first relay apparatus is an apparatus having a high requirement on power consumption reduction, for example, a satellite, if the fourth apparatus obtains quality information of an entire link between the second apparatus and the third apparatus, the fourth apparatus cannot determine, based on the quality information of the entire link, whether a signal transmit power value of a relay apparatus needs to be adjusted. However, in this embodiment, the first link is the link between the third apparatus and the first relay apparatus. Therefore, the fourth apparatus may accurately determine, based on the quality information of the first link, whether the transmit power value of the first relay apparatus needs to be reduced. In this way, a better value can be selected for power consumption reduction of the first relay apparatus and reliability of signal transmission quality, thereby achieving a better balance between the two aspects.

In another example embodiment, when the third apparatus includes a terminal, the second apparatus includes a network device, and the first link includes the link from the third apparatus to the first relay apparatus, the fourth apparatus may adjust a transmit power value of at least one of the second apparatus or another relay apparatus (for example, the second relay apparatus). For example, when link quality indicated by the quality information of the first link is not greater than a quality threshold, the fourth apparatus increases a transmit power value of the second apparatus (or the another relay apparatus). In this way, quality of a signal received by the third apparatus can be improved, thereby improving data transmission reliability. For another example, when link quality indicated by the quality information of the first link is greater than a quality threshold, the fourth apparatus reduces a transmit power value of the second apparatus (or the another relay apparatus). In this way, power consumption of the second apparatus (or the another relay apparatus) can be reduced.
Implementation B1.2: When the third apparatus includes a network device, the second apparatus includes a terminal, and the first link includes the link from the second apparatus to the second relay apparatus, the fourth apparatus may adjust the transmit power value of the second apparatus based on the quality information of the first link.

The following describes two adjustment manners by using an adjustment manner B1.2.1 and an adjustment manner B1.2.2 as examples.
Adjustment manner B1.2.1: When link quality indicated by the quality information of the first link is not greater than a quality threshold, the fourth apparatus increases the transmit power value of the second apparatus. In this way, quality of a signal received by the third apparatus can be improved, thereby improving data transmission reliability.
Adjustment manner B1.2.2: When link quality indicated by the quality information of the first link is greater than a quality threshold, the fourth apparatus reduces the transmit power value of the second apparatus. In this way, power consumption of the second apparatus can be reduced.

In another example embodiment, when the third apparatus includes a network device, the second apparatus includes a terminal, and the first link includes the link from the second apparatus to the second relay apparatus, the fourth apparatus may also adjust a transmit power value of at least one of the relay apparatuses (for example, the second relay apparatus). For example, when link quality indicated by the quality information of the first link is not greater than a quality threshold, the fourth apparatus increases a transmit power value of the relay apparatus. In this way, quality of a signal received by the third apparatus can be improved, thereby improving data transmission reliability. For another example, when link quality indicated by the quality information of the first link is greater than a quality threshold, the fourth apparatus reduces a transmit power value of the relay apparatus. In this way, power consumption of the relay apparatus can be reduced.

In another example embodiment, the fourth apparatus may determine a transmit power value of at least one of the third apparatus, the second apparatus, or the at least one relay apparatus based on the quality information of the first link and the quality information of the second link. For example, when a difference between link quality indicated by the quality information of the first link and link quality indicated by the quality information of the second link is greater than a difference threshold, the fourth apparatus may adjust a transmit power value of at least one of the third apparatus, the second apparatus, or the at least one relay apparatus based on the quality information of the first link (for a specific adjustment manner, reference is made to the foregoing adjustment manner B1.1.1, adjustment manner B1.1.2, adjustment manner B1.2.1, and adjustment manner B1.2.2). For another example, when a difference between link quality indicated by the quality information of the first link and link quality indicated by the quality information of the second link is not greater than a difference threshold, the fourth apparatus may not adjust a transmit power value of the third apparatus, the second apparatus, or the relay apparatus.

When a difference between link quality indicated by the quality information of the first link and link quality indicated by quality information of the second link is greater than a difference threshold, the fourth apparatus adjusts a transmit power value of the first relay apparatus (or the second apparatus, or another relay apparatus (for example, the second relay apparatus)), to obtain a large benefit. For example, when the fourth apparatus uses this implementation, reliability of data received by the third apparatus can be greatly improved or power consumption of the relay apparatus (or the second apparatus) can be greatly reduced by using a small transmit power value adjustment amount.
Implementation B2: The fourth apparatus determines the working mode of the relay apparatus in the at least one relay apparatus based on the quality information of the at least one link.

In this embodiment, the working mode of the relay apparatus may include a first mode and a second mode.

The following describes several possible forms of the first mode and the second mode by using the following example B2.1, example B2.2, and example B2.3.

### Example B2.1

In the example B2.1, the first mode includes a regenerative mode, and the second mode includes a transparent mode.

For descriptions of the transparent mode and the regenerative mode, reference is made to the foregoing descriptions.

### Example B2.2

In the example B2.2, if a relay apparatus meets the following content, it may be referred to as that the relay apparatus works in the first mode, or it may be referred to as that a working mode of the relay apparatus is the first mode: The relay apparatus is an apparatus having a signal regeneration capability. For example, the relay apparatus may be considered as a base station for wireless communication, has a part or all of functions of the base station, implements regeneration of signals received from the ground, and may understand and process the signals.

In the example B2.2, if a relay apparatus meets the following content, it may be referred to as that the relay apparatus works in the second mode, or it may be referred to as that a working mode of the relay apparatus is the second mode: The relay apparatus transparently transmits or replicates and forwards a received signal. It may alternatively be understood as that the relay apparatus does not regenerate a signal. For example, the relay apparatus may be considered as an analog radio frequency repeater, has a relay forwarding function, can implement radio frequency conversion and amplification, and can transparently transmit or replicate a signal between the second apparatus and the third apparatus. It may alternatively be understood as that, when the relay apparatus works in the second mode, the relay apparatus does not have a function of a base station, and does not perform processing such as regeneration on a received signal.

### Example B2.3

In the example B2.3, if a relay apparatus meets the following content, it may be referred to as that the relay apparatus works in the first mode, or it may be referred to as that a working mode of the relay apparatus is the first mode: The relay apparatus performs decode-and-forward (DF) on a received signal. In this example, the first mode may also be referred to as a DF mode.

In the example B2.3, if a relay apparatus meets the following content, it may be referred to as that the relay apparatus works in the second mode, or it may be referred to as that a working mode of the relay apparatus is the second mode. The relay apparatus performs amplify-and-forward (AF) on a received signal. In this example, the first mode may also be referred to as an AF mode. This may also be understood as that the relay apparatus does not perform a decoding operation on the received signal when the relay apparatus works in the second mode.

The fourth apparatus determines the working mode of the relay apparatus in the at least one relay apparatus based on the quality information of the at least one link. In this way, working performance of the relay apparatus can be improved, and power consumption of the relay apparatus can also be reduced.

In an example embodiment, when a difference between link quality indicated by quality information of the first link and link quality indicated by quality information of the second link is not greater than a difference threshold, the working mode of the relay apparatus in the at least one relay apparatus is the first mode. For example, the first mode is a regenerative mode, the relay apparatus is an NTN device like a satellite. When quality of links on two sides of the relay apparatus is similar, the capacity (a quantity of bits transmitted per second) of the relay apparatus in the two modes differs greatly. In this case, the relay apparatus may work in the first mode as much as possible. In the first mode, the capacity (the quantity of bits transmitted per second) of the relay apparatus is large. Therefore, this solution can improve overall system performance.

In another example embodiment, when the difference between link quality indicated by quality information of the first link and link quality indicated by quality information of the second link is greater than a difference threshold, the working mode of the relay apparatus in the at least one relay apparatus is the second mode. For example, the second mode is a transparent mode, and the relay apparatus is an NTN device like a satellite. When quality of links on two sides of the relay apparatus differs greatly, the capacity (a quantity of bits transmitted per second) of the relay apparatus in the two modes differs slightly. In this case, the relay apparatus may work in the second mode as much as possible. In the second mode, power consumption overheads of the relay apparatus are small. Therefore, this solution can reduce power consumption of the relay apparatus.

In another example embodiment, when a difference between link quality indicated by quality information of the first link and link quality indicated by quality information of the second link is equal to a difference threshold, the working mode of the relay apparatus in the at least one relay apparatus is the first mode or the second mode. In this way, solution flexibility can be improved.

In this embodiment, the quality information of the at least one link may also be helpful for another scenario. For example, the second apparatus is a base station, or the third apparatus is a base station, and the quality information of the at least one link may also assist the base station in uplink scheduling and/or downlink scheduling.

Step 609: The fourth apparatus performs at least one of the following: sending information indicating the transmit power value of the third apparatus; sending information indicating the transmit power value of the second apparatus; sending information indicating the transmit power value of the relay apparatus in the at least one relay apparatus; or sending information indicating the working mode of the relay apparatus in the at least one relay apparatus.

Step 609 is associated with step 608. In an example embodiment, if the fourth apparatus determines that a transmit power value and/or a working mode of an apparatus need/needs to be adjusted, the fourth apparatus may send corresponding information (or an instruction) to the apparatus in step 609, to adjust the transmit power value and/or the working mode of the apparatus. In another example embodiment, the fourth apparatus does not need to determine whether a transmit power value and/or a working mode of an apparatus need/needs to be adjusted. The fourth apparatus determines a transmit power value and/or a working mode of an apparatus, and sends information indicating the transmit power value and/or the working mode of the apparatus to the apparatus, so that the apparatus autonomously determines whether a current transmit power value and/or working mode needs to be adjusted.

FIG. 6 shows an example of several forms of information that may be sent by the fourth apparatus, but does not indicate that the fourth apparatus needs to send all information in step 609 shown in FIG. 6. The fourth apparatus may not perform each item of step 609 in FIG. 6, or may perform at least one item of step 609 in FIG. 6.

In this embodiment, when the fourth apparatus and the apparatus whose transmit power value or working mode is adjusted are not a same device, the fourth apparatus may send an instruction, so that the receive end adjusts the transmit power value and/or the working mode according to the instruction. When the fourth apparatus and the apparatus whose transmit power value or working mode is adjusted are a same device, the fourth apparatus may not perform step 609. The fourth apparatus adjusts a transmit power value and/or a working mode of the fourth apparatus by using an internal circuit or another unit module.

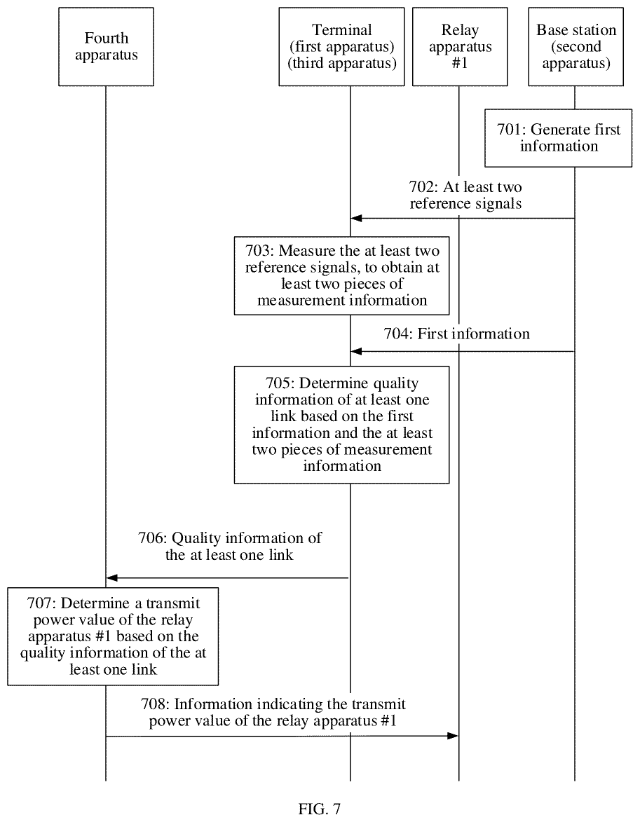

Based on the embodiments shown in FIG. 1, FIG. 2, FIG. 3, FIG. 4, FIG. 5, and FIG. 6 and the foregoing other content, FIG. 7 is an example of a schematic flowchart of another communication method according to an embodiment of this disclosure. FIG. 7 may be considered as an example embodiment of FIG. 6. In the example shown in FIG. 7, a second apparatus is a base station, a first relay apparatus is the relay apparatus #1 in FIG. 5, a third apparatus is a terminal, and a first apparatus and the third apparatus are apparatuses on a same device, or the first apparatus and the third apparatus are a same apparatus.

As shown in FIG. 7, the method includes the following steps.

Step 701: The base station generates first information.

For related content of step 701, reference is made to the descriptions of step 601.

Step 702: The base station sends at least two reference signals based on the first information.

For related content of step 702, reference is made to the descriptions of step 602.

Step 703: The terminal measures the at least two reference signals, to obtain at least two pieces of measurement information.

The base station may send a large quantity of reference signals, so that the terminal obtains more measurement results of the reference signals. More measurement results of the reference signals help improve positioning accuracy. In addition, after obtaining the large quantity of measurement results, the terminal may perform smoothing processing on the measurement results of the plurality of reference signals, for example, may perform smoothing processing on the plurality of measurement results through alpha filtering.

For related content of step 703, reference is made to the descriptions of step 603.

Step 704: The base station sends the first information.

Correspondingly, the terminal receives the first information.

For related content of step 704, reference is made to the descriptions of step 604.

Step 705: The terminal determines quality information of at least one link based on the first information and the at least two pieces of measurement information.

For related content of step 705, reference is made to the descriptions of step 606.

Step 706: The terminal sends the quality information of the at least one link.

Correspondingly, the fourth apparatus receives the quality information of the at least one link.

In step 706, the terminal may first send the quality information of the at least one link to the base station, and then the base station sends the quality information of the at least one link to the fourth apparatus.

For related content of step 706, reference is made to the descriptions of step 607.

Step 707: The fourth apparatus determines a transmit power value of the relay apparatus #1 based on the quality information of the at least one link.

For related content of step 707, reference is made to the descriptions of step 608.

Step 708: The fourth apparatus sends, to the relay apparatus #1, information indicating the transmit power value of the relay apparatus #1.

Correspondingly, the relay apparatus #1 receives the information indicating the transmit power value of the relay apparatus #1.

In an example embodiment, if the fourth apparatus determines that the transmit power value of the relay apparatus #1 needs to be adjusted, the fourth apparatus may send corresponding information (or an instruction) to the relay apparatus #1 in step 709, to adjust the transmit power value of the relay apparatus #1.

In another example embodiment, the fourth apparatus does not need to determine whether the transmit power value of the relay apparatus #1 needs to be adjusted. The fourth apparatus determines the transmit power value of the relay apparatus #1, and sends information indicating the determined transmit power value of the relay apparatus #1 to the relay apparatus #1, so that the relay apparatus #1 determines, based on a current transmit power value and the received transmit power value, whether the current transmit power value needs to be adjusted.

In another example embodiment, in the embodiment shown in FIG. 7, the relay apparatus #1 works in a second mode (for example, a transparent mode or an AF mode). In this implementation, when the relay apparatus #1 works in the second mode, and a current transmit power value of the relay apparatus #1 is different from the transmit power value that is of the relay apparatus #1 and that is determined by the fourth apparatus based on the quality information of a first link, the four apparatus (or the relay apparatus #1) determines, based on quality information of the first link and/or quality information of a second link, that the transmit power value of the relay apparatus #1 needs to be adjusted. It can be learned that, in this embodiment, a manner of adjusting the transmit power is provided for the relay apparatus working in the second mode (for example, the transparent mode or the AF mode), so that the relay apparatus working in the second mode reduces power consumption as much as possible when satisfying link quality.

In another example embodiment, in the embodiment shown in FIG. 7, when the relay apparatus #1 works in a first mode (for example, a regenerative mode or a DF mode) or a non-second mode, the fourth apparatus (or the relay apparatus #1) does not need to adjust a transmit power value of the relay apparatus #1 based on quality information of a first link and/or quality information of a second link. Because the relay apparatus #1 working in the first mode has a function of the base station, the relay apparatus #1 may adjust the transmit power value of the relay apparatus #1 in another manner. For example, the relay apparatus #1 may adjust the transmit power in a manner similar to that of the base station. For example, the relay apparatus #1 adjusts the transmit power value of the relay apparatus #1 based on measurement result information of a received signal.

In an example embodiment, the information that is sent by the fourth apparatus and that indicates the transmit power value of the relay apparatus #1 may include an adjusted transmit power value of the relay apparatus #1, or include some adjustment parameters. The information indicating the transmit power value of the relay apparatus #1 includes information indicating adjustment amplitudes for the relay apparatus #1 in terms of an analog domain and a digital domain. For example, the digital domain of the relay apparatus #1 is amplified by four times, and the analog domain of the relay apparatus #1 is amplified by two times. In this way, a total transmit power value of the relay apparatus #1 may be amplified by eight times.

It can be learned from the example in FIG. 7 that the base station sends a plurality of reference signals to the terminal. In the solution provided in this embodiment, the terminal may determine quality information of a link between the terminal and the relay apparatus #1 based on a measurement result obtained by measuring the plurality of reference signals, and then feed back the quality information to the fourth apparatus. The fourth apparatus may determine, based on the quality information of the link between the terminal and the relay apparatus #1, whether the transmit power value of the relay apparatus #1 needs to be adjusted. If quality of the link between the terminal and the relay apparatus #1 is poor, the fourth apparatus may indicate to increase the transmit power value of the relay apparatus #1, to improve quality of a signal received on the terminal side. If quality of the link between the terminal and the relay apparatus #1 is good, the fourth apparatus may indicate to reduce the transmit power value of the relay apparatus #1, to reduce power consumption of the relay apparatus #1.

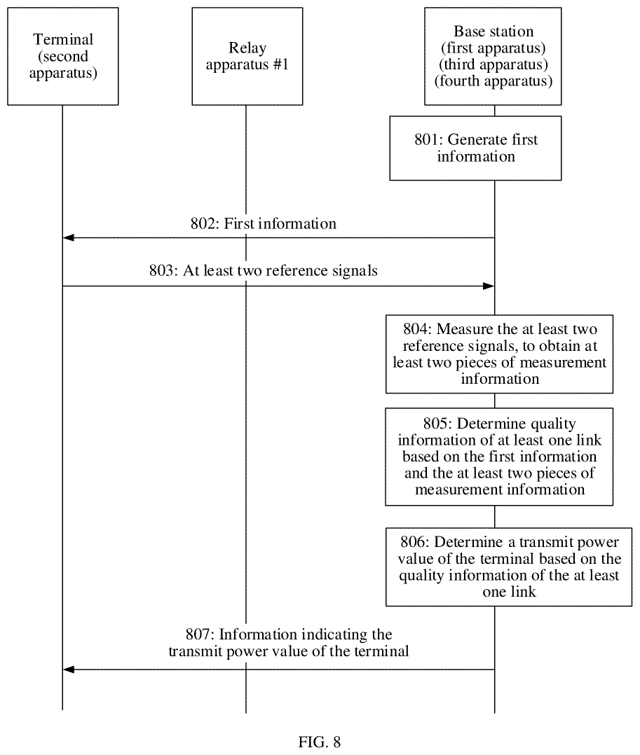

Based on the embodiments shown in FIG. 1, FIG. 2, FIG. 3, FIG. 4, FIG. 5, FIG. 6, and FIG. 7 and the foregoing other content, FIG. 8 is an example of a schematic flowchart of another communication method according to an embodiment of this disclosure. FIG. 8 may be considered as an example embodiment of FIG. 6. In the example shown in FIG. 8, a second apparatus is a terminal, a second relay apparatus is the relay apparatus #2 in FIG. 5, a third apparatus is a base station, and a first apparatus, the third apparatus, and a fourth apparatus are apparatuses on a same device, or the first apparatus, the third apparatus, and the fourth apparatus are a same apparatus.

As shown in FIG. 8, the method includes the following steps.

Step 801: The base station generates first information.

For related content of step 801, reference is made to the descriptions of step 601.

Step 802: The base station sends the first information.

Correspondingly, the terminal receives the first information.

For related content of step 802, reference is made to the descriptions of step 604.

Step 803: The terminal sends at least two reference signals based on the first information.

For related content of step 803, reference is made to the descriptions of step 602.

Step 804: The base station measures the at least two reference signals, to obtain at least two pieces of measurement information.

The terminal may send a large quantity of reference signals, so that the base station obtains more measurement results of the reference signals. More measurement results of the reference signals help improve positioning accuracy. In addition, after obtaining the large quantity of measurement results, the base station may perform smoothing processing on the measurement results of the plurality of reference signals, for example, may perform smoothing processing on the plurality of measurement results through alpha filtering.

For related content of step 804, reference is made to the descriptions of step 603.

Step 805: The base station determines quality information of at least one link based on the first information and the at least two pieces of measurement information.

For related content of step 805, reference is made to the descriptions of step 606.

Step 806: The base station determines a transmit power value of the terminal based on the quality information of the at least one link.

For related content of step 806, reference is made to the descriptions of step 608.

Step 807: The base station sends, to the terminal, information indicating the transmit power value of the terminal.

Correspondingly, the terminal receives the information indicating the transmit power value of the terminal.

In an example embodiment, if the base station determines that the transmit power value of the terminal needs to be adjusted, the base station may send corresponding information (or an instruction) to the terminal in step 807, to adjust the transmit power value of the terminal.

In another example embodiment, the base station does not need to determine whether the transmit power value of the terminal needs to be adjusted. The base station determines the transmit power value of the terminal, and sends, to the terminal, information indicating the determined transmit power value of the terminal, so that the terminal determines, based on a current transmit power value and the received transmit power value, whether the current transmit power value needs to be adjusted.

In another example embodiment, in the embodiment shown in FIG. 8, the relay apparatus #1 works in a second mode (for example, a transparent mode or an AF mode). In this implementation, when the relay apparatus #1 works in the second mode, and a current transmit power value of the terminal is different from the transmit power value that is of the terminal and that is determined by the base station based on quality information of a first link, the base station (or the terminal) may determine that the transmit power value of the terminal needs to be adjusted. Because the relay apparatus #1 works in the second mode (for example, the transparent mode or the AF mode), power adjustment efficiency of the terminal may be reduced. Therefore, when determining the transmit power value of the terminal, the base station may adjust the transmit power value of the terminal more accurately based on the quality information of the first link and/or quality information of a second link.

In another example embodiment, in the embodiment shown in FIG. 8, when the relay apparatus #1 works in a first mode (for example, a regenerative mode or a DF mode) or a non-second mode, the base station (or the terminal) may also adjust a transmit power value of the terminal. However, because power adjustment efficiency of the terminal may be high when the relay apparatus works in the first mode, the base station may not need to adjust the transmit power value of the terminal based on quality information of a first link and/or quality information of a second link. For example, the base station may also adjust the transmit power value of the terminal accurately based on the measurement information of the reference signals.

In an example embodiment, the information that is sent by the base station and that indicates the transmit power value of the terminal may include an adjusted transmit power value of the terminal, or include some adjustment parameters. The information indicating the transmit power value of the terminal includes information indicating adjustment amplitudes for the terminal in terms of an analog domain and a digital domain. For example, the digital domain of the terminal is amplified by four times, and the analog domain of the terminal is amplified by two times. In this way, a total transmit power value of the terminal may be amplified by eight times.

It can be learned from the example in FIG. 8 that the terminal sends a plurality of reference signals to the base station, and the base station may determine quality information of a link between the terminal and the relay apparatus #1 based on measurement results obtained by measuring the plurality of reference signals, and then determine, based on the quality information of the link between the terminal and the relay apparatus #1, whether a transmit power value of the terminal needs to be adjusted. If the quality of the link between the terminal and the relay apparatus #1 is poor, the base station may indicate to increase the transmit power value of the terminal, to improve quality of a signal received on the base station side. If the quality of the link between the terminal and the relay apparatus #1 is good, the base station may indicate to reduce the transmit power value of the terminal, to reduce power consumption of the terminal.

It may be understood that, to implement functions in the foregoing embodiments, the base station and the terminal include corresponding hardware structures and/or software modules for performing the functions. A person skilled in the art should be easily aware that, with reference to units and method steps of the examples described in embodiments disclosed in this disclosure, this disclosure can be implemented by hardware or a combination of hardware and computer software. Whether a function is performed by hardware or hardware driven by computer software depends on particular application scenarios and design constraint conditions of the technical solutions.

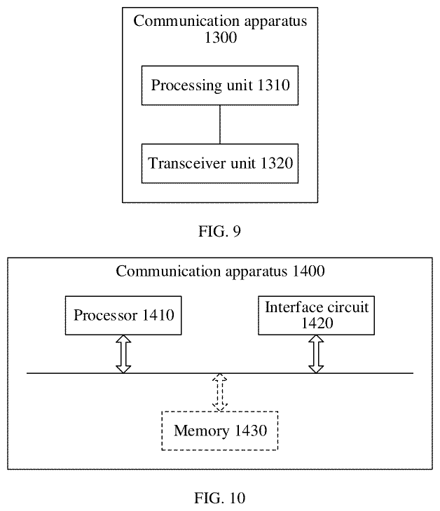

FIG. 9 and FIG. 10 are diagrams of structures of possible communication apparatuses according to embodiments of this disclosure. These communication apparatuses may be configured to implement functions of the terminal or the base station in the foregoing method embodiments, and therefore can also implement beneficial effects of the foregoing method embodiments. In this embodiment, the communication apparatus may be the terminal 120 shown in FIG. 1, or may be the RAN node 110 shown in FIG. 1, or may be a module (for example, a chip) used in the terminal 120 or the RAN node 110. The communication apparatus may alternatively be a satellite in FIG. 2 or FIG. 3 or a module (for example, a chip) used in the satellite.

As shown in FIG. 9, a communication apparatus 1300 includes a processing unit 1310 and a transceiver unit 1320. The communication apparatus 1300 is configured to implement functions of the first apparatus, the second apparatus, the third apparatus, or the fourth apparatus in the method embodiment shown in FIG. 6, FIG. 7, or FIG. 8.

When the communication apparatus 1300 is configured to implement the functions of the first apparatus in the method embodiment shown in FIG. 6, FIG. 7, or FIG. 8, the processing unit 1310 is configured to perform the following operations by using the transceiver unit 1320: obtaining first information, obtaining at least two pieces of measurement information, and determining quality information of at least one link based on the first information and the at least two pieces of measurement information.

In an example embodiment, when the communication apparatus 1300 is configured to implement the functions of the first apparatus in the method embodiment shown in FIG. 6, FIG. 7, or FIG. 8, the processing unit 1310 is specifically configured to: when the first apparatus and the third apparatus are a same apparatus, receive at least two reference signals from the second apparatus by using the transceiver unit 1320, and measure the at least two reference signals, to obtain the at least two pieces of measurement information.

In an example embodiment, when the communication apparatus 1300 is configured to implement the functions of the first apparatus in the method embodiment shown in FIG. 6, FIG. 7, or FIG. 8, the transceiver unit 1320 is specifically configured to receive the at least two pieces of measurement information.

In an example embodiment, when the communication apparatus 1300 is configured to implement the functions of the first apparatus in the method embodiment shown in FIG. 6, FIG. 7, or FIG. 8, the processing unit 1310 is specifically configured to determine, based on the quality information of the at least one link, a transmit power value of at least one of the third apparatus, the second apparatus, or the at least one relay apparatus, and/or a working mode of a relay apparatus in the at least one relay apparatus.

In an example embodiment, when the communication apparatus 1300 is configured to implement the functions of the first apparatus in the method embodiment shown in FIG. 6, FIG. 7, or FIG. 8, the processing unit 1310 is specifically configured to generate the first information.

In an example embodiment, when the communication apparatus 1300 is configured to implement the functions of the first apparatus in the method embodiment shown in FIG. 6, FIG. 7, or FIG. 8, the transceiver unit 1320 is specifically configured to receive the first information.

In an example embodiment, when the communication apparatus 1300 is configured to implement the functions of the first apparatus in the method embodiment shown in FIG. 6, FIG. 7, or FIG. 8, the transceiver unit 1320 is further configured to send the quality information of the at least one link.

When the communication apparatus 1300 is configured to implement the functions of the fourth apparatus in the method embodiment shown in FIG. 6, FIG. 7, or FIG. 8, the processing unit 1310 is configured to perform the following operations by using the transceiver unit 1320: obtaining quality information of at least one link, and determining, based on the quality information of the at least one link, a transmit power value of at least one of the third apparatus, the second apparatus, or at least one relay apparatus.

In an example embodiment, when the communication apparatus 1300 is configured to implement the functions of the fourth apparatus in the method embodiment shown in FIG. 6, FIG. 7, or FIG. 8, the processing unit 1310 is specifically configured to: when the third apparatus includes a terminal, the second apparatus includes a network device, and a first link includes a link from the third apparatus to a first relay apparatus, if link quality indicated by quality information of the first link is not greater than a quality threshold, determine to increase a transmit power value of a first relay apparatus; or if link quality indicated by quality information of the first link is greater than a quality threshold, determine to reduce a transmit power value of a first relay apparatus.

In an example embodiment, when the communication apparatus 1300 is configured to implement the functions of the fourth apparatus in the method embodiment shown in FIG. 6, FIG. 7, or FIG. 8, the processing unit 1310 is specifically configured to: when the third apparatus includes a network device, the second apparatus includes a terminal, and a first link includes a link from the second apparatus to a second relay apparatus, if link quality indicated by quality information of the first link is not greater than a quality threshold, determine to increase a transmit power value of the second apparatus; or if link quality indicated by quality information of the first link is greater than a quality threshold, determine to reduce a transmit power value of the second apparatus.

In an example embodiment, when the communication apparatus 1300 is configured to implement the functions of the fourth apparatus in the method embodiment shown in FIG. 6, FIG. 7, or FIG. 8, the processing unit 1310 is specifically configured to: when link quality indicated by quality information of a first link is not greater than a quality threshold, and a difference between the link quality indicated by the quality information of the first link and link quality indicated by quality information of a second link is greater than a difference threshold, determine the transmit power value of the at least one of the third apparatus, the second apparatus, or at least one relay apparatus based on the quality information of the at least one link.

In an example embodiment, when the communication apparatus 1300 is configured to implement the functions of the fourth apparatus in the method embodiment shown in FIG. 6, FIG. 7, or FIG. 8, the transceiver unit 1320 is specifically configured to perform at least one of the following: sending information indicating a transmit power value of the third apparatus; sending information indicating a transmit power value of the second apparatus; or sending information indicating a transmit power value of a relay apparatus in at least one relay apparatus.

When the communication apparatus 1300 is configured to implement the functions of the fourth apparatus in the method embodiment shown in FIG. 6, FIG. 7, or FIG. 8, the processing unit 1310 is configured to perform the following operations by using the transceiver unit 1320: obtaining the quality information of the at least one link, and determining a working mode of a relay apparatus in the at least one relay apparatus based on the quality information of the at least one link.

In an example embodiment, when the communication apparatus 1300 is configured to implement the functions of the fourth apparatus in the method embodiment shown in FIG. 6, FIG. 7, or FIG. 8, the processing unit 1310 is specifically configured to: when a difference between link quality indicated by quality information of a first link and link quality indicated by quality information of a second link is not greater than a difference threshold, the working mode of the relay apparatus in the at least one relay apparatus is a first mode; or when a difference between link quality indicated by quality information of a first link and link quality indicated by quality information of a second link is greater than a difference threshold, the working mode of the relay apparatus in the at least one relay apparatus is a second mode.

In an example embodiment, when the communication apparatus 1300 is configured to implement the functions of the fourth apparatus in the method embodiment shown in FIG. 6, FIG. 7, or FIG. 8, the processing unit 1310 is specifically configured to: when a difference between link quality indicated by quality information of a first link and link quality indicated by quality information of a second link is equal to a difference threshold, the working mode of the relay apparatus in the at least one relay apparatus is a first mode or a second mode.

In an example embodiment, when the communication apparatus 1300 is configured to implement the functions of the fourth apparatus in the method embodiment shown in FIG. 6, FIG. 7, or FIG. 8, the transceiver unit 1320 is further configured to send information indicating the working mode of the relay apparatus in the at least one relay apparatus.

When the communication apparatus 1300 is configured to implement the functions of the second apparatus in the method embodiment shown in FIG. 6, FIG. 7, or FIG. 8, the processing unit 1310 is configured to perform the following operations by using the transceiver unit 1320: obtaining first information, and sending at least two reference signals based on the first information.

In an example embodiment, when the communication apparatus 1300 is configured to implement the functions of the second apparatus in the method embodiment shown in FIG. 6, FIG. 7, or FIG. 8, the transceiver unit 1320 is further configured to send the first information.

When the communication apparatus 1300 is configured to implement the functions of the third apparatus in the method embodiment shown in FIG. 6, FIG. 7, or FIG. 8, the transceiver unit 1320 is configured to receive at least two reference signals. The processing unit 1310 is configured to measure the at least two reference signals, to obtain at least two pieces of measurement information.

For more detailed descriptions of the processing unit 1310 and the transceiver unit 1320, reference is made to related descriptions in the method embodiment shown in FIG. 6, FIG. 7, or FIG. 8.

As shown in FIG. 10, a communication apparatus 1400 includes a processor 1410 and an interface circuit 1420. The processor 1410 and the interface circuit 1420 are coupled to each other. It can be understood that the interface circuit 1420 may be a transceiver or an input/output interface. Optionally, the communication apparatus 1400 may further include a memory 1430, configured to: store instructions executed by the processor 1410, or store input data required for running instructions by the processor 1410, or store data generated after the processor 1410 runs instructions.

When the communication apparatus 1400 is configured to implement the method shown in FIG. 6, FIG. 7, or FIG. 8, the processor 1410 is configured to implement a function of the processing unit 1310, and the interface circuit 1420 is configured to implement a function of the transceiver unit 1320.

When the communication apparatus is a chip used in a terminal, the chip in the terminal implements a function of the terminal apparatus in the foregoing method embodiments. That the chip in the terminal receives information from a base station may be understood as that the information is first received by another module (for example, a radio frequency module or an antenna) in the terminal, and then sent by the module to the chip in the terminal. That the chip in the terminal sends information to a base station may be understood as that the information is first sent to another module (for example, a radio frequency module or an antenna) in the terminal, and then sent to the base station by the module.

When the communication apparatus is a chip used in a base station, the chip in the base station implements a function of the network apparatus in the method embodiments. That the chip in the base station receives information from a terminal may be understood as that the information is first received by another module (for example, a radio frequency module or an antenna) in the base station, and then sent by the module to the chip in the base station. That the chip in the base station sends information to a terminal may be understood as that the information is first sent to another module (for example, a radio frequency module or an antenna) in the base station, and then sent to the terminal by the module.

In this disclosure, that an entity A sends information to an entity B may be that A directly sends the information to B, or may be that A indirectly sends the information to B via another entity. Similarly, that the entity B receives the information from the entity A may be that the entity B directly receives the information sent by the entity A, or may be that the entity B indirectly receives the information sent by the entity A via another entity. The entities A and B herein each may be a RAN node or a terminal, or may be a module inside the RAN node or the terminal. Information receiving and sending may be information exchange between a RAN node and a terminal, for example, information exchange between a base station and a terminal. Information receiving and sending may alternatively be information exchange between two RAN nodes, for example, information exchange between a CU and a DU. Information receiving and sending may alternatively be information exchange between different modules inside an apparatus, for example, information exchange between a chip in a terminal and another module in the terminal, or information exchange between a chip in a base station and another module in the base station.

It can be understood that the processor in embodiments of this disclosure may be a central processing unit (CPU), or may be another general-purpose processor, a digital signal processor (DSP), an application-specific integrated circuit (ASIC), a field programmable gate array (FPGA) or another programmable logic device, a transistor logic device, a hardware component, or any combination thereof. The general-purpose processor may be a microprocessor or any conventional processor.

The method steps in embodiments of this disclosure may be implemented in hardware, or may be implemented in software instructions that may be executed by the processor. The software instructions may include a corresponding software module. The software module may be stored in a random access memory, a flash memory, a read-only memory, a programmable read-only memory, an erasable programmable read-only memory, an electrically erasable programmable read-only memory, a register, a hard disk, a removable hard disk, a CD-ROM, or any other form of storage medium well-known in the art. For example, a storage medium is coupled to the processor, so that the processor can read information from the storage medium and write information into the storage medium. The storage medium may alternatively be a component of the processor. The processor and the storage medium may be located in an ASIC. In addition, the ASIC may be located in a base station or a terminal. The processor and the storage medium may exist in a base station or terminal as discrete components.

All or some of the foregoing embodiments may be implemented by using software, hardware, firmware, or any combination thereof. When software is used to implement embodiments, all or some of embodiments may be implemented in the form of a computer program product. The computer program product includes one or more computer programs or instructions. When the computer programs or the instructions are loaded and executed on a computer, the procedures or the functions in embodiments of this disclosure are all or partially executed. The computer may be a general-purpose computer, a dedicated computer, a computer network, a network device, user equipment, or another programmable apparatus. The computer program or the instructions may be stored in a computer-readable storage medium, or may be transmitted from a computer-readable storage medium to another computer-readable storage medium. For example, the computer program or the instructions may be transmitted from a website, computer, server, or data center to another website, computer, server, or data center in a wired or wireless manner. The computer-readable storage medium may be any usable medium that can be accessed by the computer, or a data storage device, for example, a server or a data center, integrating one or more usable media. The usable medium may be a magnetic medium, for example, a floppy disk, a hard disk, or a magnetic tape; or may be an optical medium, for example, a digital video disc; or may be a semiconductor medium, for example, a solid-state drive. The computer-readable storage medium may be a volatile or non-volatile storage medium, or may include two types of storage media: a volatile storage medium and a non-volatile storage medium.

In various embodiments of this disclosure, unless otherwise stated or there is a logic conflict, terms and/or descriptions in different embodiments are consistent and may be mutually referenced, and technical features in different embodiments may be combined based on an internal logical relationship thereof, to form a new embodiment.

In this disclosure, at least one means one or more, and a plurality of means two or more. The term “and/or” describes an association relationship between associated objects, and indicates that three relationships may exist. For example, A and/or B may indicate one of the following cases: Only A exists, both A and B exist, or only B exists, where A and B may be singular or plural. In the text descriptions of this disclosure, the character “/” represents an “or” relationship between the associated objects. In a formula in this disclosure, the character “/” represents a “division” relationship between the associated objects. “Including at least one of A, B, and C” may represent: including A; including B; including C; including A and B; including A and C; including B and C; and including A, B, and C.

It may be understood that various numbers (for example, digital numbers “first” and “second”, and letter numbers “parameter A”, “parameter B”, and “parameter C”) in embodiments of this disclosure are merely used for differentiation for ease of description, and are not used to limit the scope of embodiments of this disclosure. Sequence numbers of the foregoing processes do not mean an execution sequence, and the execution sequence of the processes should be determined based on functions and internal logic of the processes.

1. A method, applicable to a first apparatus, and comprising:
obtaining first information indicating a relationship between transmit power values of at least two reference signals sent by a second apparatus;
obtaining at least two pieces of measurement information based on the at least two reference signals from the second apparatus; and
determining quality information of at least one link based on the first information and the at least two pieces of measurement information, wherein at least one relay apparatus is located between a third apparatus and the second apparatus, the at least one link comprises a first link, the first link comprises a link from the second apparatus to a second relay apparatus or a link from the third apparatus to a first relay apparatus, and the first relay apparatus and the second relay apparatus are a same relay apparatus or different relay apparatuses in the at least one relay apparatus.

2. The method according to claim 1, wherein obtaining the at least two pieces of measurement information comprises:
when the first apparatus and the third apparatus are a same apparatus, receiving the at least two reference signals from the second apparatus, wherein the first apparatus measures the at least two reference signals to obtain the at least two pieces of measurement information; or
receiving the at least two pieces of measurement information.

3. The method according to claim 1, wherein when the third apparatus comprises a terminal, and the second apparatus comprises a network device, the first link comprises the link from the third apparatus to the first relay apparatus; or
when the third apparatus comprises a network device, and the second apparatus comprises a terminal, the first link comprises the link from the second apparatus to the second relay apparatus.

4. The method according to claim 1, wherein the at least one link comprises a second link; and
when the first link comprises the link from the third apparatus to the first relay apparatus, the second link comprises a link from the first relay apparatus to the second apparatus; or
when the first link comprises the link from the second apparatus to the second relay apparatus, the second link comprises a link from the second relay apparatus to the third apparatus.

5. The method according to claim 1, wherein the quality information of the at least one link is configured to support determining at least one of:
a transmit power value of the third apparatus;
a transmit power value of the second apparatus;
a transmit power value of a relay apparatus in the at least one relay apparatus; or
a working mode of a relay apparatus in the at least one relay apparatus.

6. The method according to claim 5, further comprising:
determining the following based on the quality information of the at least one link:
a transmit power value of at least one of the third apparatus, the second apparatus, or the at least one relay apparatus; or
the working mode of the relay apparatus in the at least one relay apparatus.

7. The method according to claim 1, wherein after determining the quality information of the at least one link based on the first information and the at least two pieces of measurement information, the method further comprises:
sending the quality information of the at least one link.

8. A first apparatus, comprising:
a transceiver; and
at least one processor coupled to one or more memories storing programming instructions that, when executed by the at least one processor, cause the first apparatus to:
obtain first information indicating a relationship between transmit power values of at least two reference signals sent by a second apparatus;
obtain at least two pieces of measurement information based on the at least two reference signals from the second apparatus; and
determine quality information of at least one link based on the first information and the at least two pieces of measurement information, wherein at least one relay apparatus is located between a third apparatus and the second apparatus, the at least one link comprises a first link, the first link comprises a link from the second apparatus to a second relay apparatus or a link from the third apparatus to a first relay apparatus, and the first relay apparatus and the second relay apparatus are a same relay apparatus or different relay apparatuses in the at least one relay apparatus.

9. The first apparatus according to claim 8, wherein the programming instructions, when executed by the at least one processor, further cause the first apparatus to:
when the first apparatus and the third apparatus are a same apparatus, receive the at least two reference signals from the second apparatus, wherein the first apparatus measures the at least two reference signals to obtain the at least two pieces of measurement information; or
receive the at least two pieces of measurement information.

10. The first apparatus according to claim 8, wherein when the third apparatus comprises a terminal, and the second apparatus comprises a network device, the first link comprises the link from the third apparatus to the first relay apparatus; or
when the third apparatus comprises a network device, and the second apparatus comprises a terminal, the first link comprises the link from the second apparatus to the second relay apparatus.

11. The first apparatus according to claim 8, wherein the at least one link comprises a second link; and
when the first link comprises the link from the third apparatus to the first relay apparatus, the second link comprises a link from the first relay apparatus to the second apparatus; or
when the first link comprises the link from the second apparatus to the second relay apparatus, the second link comprises a link from the second relay apparatus to the third apparatus.

12. The first apparatus according to claim 8, wherein the quality information of the at least one link is configured to support determining at least one of:
a transmit power value of the third apparatus;
a transmit power value of the second apparatus;
a transmit power value of a relay apparatus in the at least one relay apparatus; or
a working mode of a relay apparatus in the at least one relay apparatus.

13. The first apparatus according to claim 12, wherein the programming instructions, when executed by the at least one processor, further cause the first apparatus to:
determine the following based on the quality information of the at least one link:
a transmit power value of at least one of the third apparatus, the second apparatus, or the at least one relay apparatus; or
the working mode of the relay apparatus in the at least one relay apparatus.

14. The first apparatus according to claim 8, wherein the programming instructions, when executed by the at least one processor, further cause the first apparatus to:
transmit the quality information of the at least one link.

15. A non-transitory computer-readable storage medium storing computer instructions, wherein the computer instructions, when executed by at least one processor of a first apparatus, cause the first apparatus to perform operations comprising:
obtaining first information indicating a relationship between transmit power values of at least two reference signals sent by a second apparatus;
obtaining at least two pieces of measurement information based on the at least two reference signals from the second apparatus; and
determining quality information of at least one link based on the first information and the at least two pieces of measurement information, wherein at least one relay apparatus is located between a third apparatus and the second apparatus, the at least one link comprises a first link, the first link comprises a link from the second apparatus to a second relay apparatus or a link from the third apparatus to a first relay apparatus, and the first relay apparatus and the second relay apparatus are a same relay apparatus or different relay apparatuses in the at least one relay apparatus.

16. The non-transitory computer-readable storage medium according to claim 15, wherein the computer instructions, when executed by the at least one processor, further cause the first apparatus to further perform operations comprising:
when the first apparatus and the third apparatus are a same apparatus, receiving the at least two reference signals from the second apparatus, wherein the first apparatus measures the at least two reference signals to obtain the at least two pieces of measurement information; or
receiving the at least two pieces of measurement information.

17. The non-transitory computer-readable storage medium according to claim 15, wherein when the third apparatus comprises a terminal, and the second apparatus comprises a network device, the first link comprises the link from the third apparatus to the first relay apparatus; or
when the third apparatus comprises a network device, and the second apparatus comprises a terminal, the first link comprises the link from the second apparatus to the second relay apparatus.

18. The non-transitory computer-readable storage medium according to claim 15, wherein the at least one link comprises a second link; and
when the first link comprises the link from the third apparatus to the first relay apparatus, the second link comprises a link from the first relay apparatus to the second apparatus; or
when the first link comprises the link from the second apparatus to the second relay apparatus, the second link comprises a link from the second relay apparatus to the third apparatus.

19. The non-transitory computer-readable storage medium according to claim 15, wherein the quality information of the at least one link is configured to support determining at least one of:
a transmit power value of the third apparatus;
a transmit power value of the second apparatus;
a transmit power value of a relay apparatus in the at least one relay apparatus; or
a working mode of a relay apparatus in the at least one relay apparatus.

20. The non-transitory computer-readable storage medium according to claim 19, wherein the computer instructions, when executed by the at least one processor, further cause the first apparatus to further perform operations comprising:
determining the following based on the quality information of the at least one link:
a transmit power value of at least one of the third apparatus, the second apparatus, or the at least one relay apparatus; or
the working mode of the relay apparatus in the at least one relay apparatus.
